(19) United States
(12) Patent Application Publication
(10) Pub. No.: US 2026/0370492 A1
(43) Pub. Date: Nov. 19, 2026

(54) GOVERNING CONDITIONAL EXECUTION OF OPERATIONS ACROSS A PLURALITY OF INDEPENDENT COMPUTING ENVIRONMENTS

(71) Applicant: Cipher Licensing Group, LLC, Bronx, NY (US)

(72) Inventor: Trent Banks, Bronx, NY (US)

(21) Appl. No.: 19/677,188

(22) Filed: May 14, 2026

Related U.S. Application Data
(60) Provisional application No. 63/805,466, filed on May 14, 2025.

(51) Int. Cl. H04L 9/32

(52) U.S. Cl. CPC H04L 9/3247

(57) ABSTRACT

A method, system, and computer program product are provided for governing conditional execution of operations across a plurality of independent computing environments. A machine-readable execution governance payload associated with a participating entity is generated, encapsulating an authorization state of the participating entity, one or more conditional execution constraints applicable to the participating entity, and one or more enforcement directives. An execution request to release, transfer, or settle a digital payload held in a conditional holding state on behalf of the participating entity is received from a requesting platform. The execution request is evaluated against the execution governance payload, and an enforcement outcome specifying whether release, transfer, or settlement is permitted, restricted, or denied is determined. The enforcement outcome is enforced by propagating the execution governance payload, as updated, to the plurality of independent computing environments as an authoritative execution condition.

### CROSS-REFERENCE TO RELATED APPLICATIONS

This application claims the benefit of priority to U.S. Provisional Patent Application No. 63/805,466, filed May 14, 2025, and titled "CipherVault Metaverse Based Digital Banking Escrow Loan and Insurance Infrastructure Platform for Immersive Commerce and Decentralized Transactions," the entire contents of which are hereby incorporated by reference in their entirety for all purposes.

### FIELD OF INVENTION

The present disclosure relates to governance of conditional execution of operations across distributed computing platforms, and more particularly to a system and method for generating, propagating, and enforcing a machine-readable execution governance payload that binds a plurality of independent computing environments to apply an authorization state, conditional execution constraints, and enforcement directives associated with a participating entity with respect to a digital payload held in a conditional holding state.

### BACKGROUND

Digital commerce, decentralized finance, immersive virtual environments, and platform-mediated services have grown rapidly, and operations that affect digital assets, accounts, and entitlements are now routinely initiated, processed, and settled across a plurality of independent computing environments. A single transfer, settlement, or release of a digital payload may traverse a requesting platform, a settlement platform, a marketplace platform, a regulated exchange platform, and one or more distributed ledger networks, each operated by a distinct provider and each maintaining its own internal state.

Authorization and access control in such environments are generally implemented platform-by-platform. Each platform tends to maintain its own credentialing, session management, and authorization logic, and existing authentication mechanisms such as username and password combinations, federated login systems, token-based authentication frameworks, and cryptographic signing schemes are typically scoped to a single application or service. As a result, an authorization decision rendered in one environment is not necessarily reflected in another, and changes in the status of a participating entity, such as a suspension, a compliance violation, a revocation of delegated authority, or a change in jurisdictional eligibility, are not consistently observed by other environments that may concurrently be processing operations on behalf of the same entity.

Conventional smart contracts and programmable transaction frameworks can automate the execution of predefined conditions and transfer digital assets between parties without intermediary involvement. However, such mechanisms are generally bound to a particular ledger or platform, and they tend to evaluate a narrow set of on-chain inputs at the moment of execution. They are not generally well suited to expressing or uniformly applying broader conditional execution constraints, such as delegated permissions, jurisdictional restrictions, regulatory compliance conditions, or behavioral restrictions, across heterogeneous platforms operating in synchronous, asynchronous, and distributed modes.

The growing use of automated and autonomous software agents, including artificial-intelligence agents that initiate operations on behalf of users or businesses, introduces further considerations for cross-platform authorization. Such agents may operate continuously, may act across multiple platforms, and may chain operations together in ways that are difficult to constrain through platform-local controls alone. Mechanisms for binding the execution authority of an agent to a participating entity, for scoping that authority, and for revoking or modifying the scope in a manner that propagates to all platforms on which the agent may act, remain areas of ongoing development.

Holding constructs such as escrow accounts, pending-transfer states, and conditional release arrangements are widely used to defer release, transfer, or settlement of a digital payload until one or more conditions are satisfied. In practice, the conditions, the holding state, and the release logic are often implemented within a single platform or contract, which can make it difficult to coordinate consistent treatment of a held digital payload when the payload is referenced by, or affects operations within, multiple independent computing environments. Time-based expirations, freezes, suspensions, revocations, and rollbacks applied at one platform are not necessarily mirrored at others.

Coordination of state changes across independent platforms also raises practical considerations relating to versioning, acknowledgment, and reconciliation. When an authorization decision or enforcement directive is updated, downstream platforms may receive the update at different times or may fail to receive it at all due to network conditions or platform-side processing delays. Without a uniform mechanism for versioning updates, confirming application of an update at each platform, and reconciling missed or invalid acknowledgments, divergent enforcement states can persist across the environments processing operations on behalf of the same participating entity.

Auditability and tamper-resistance present additional considerations. Records of authorization decisions, enforcement actions, and operations performed on a held digital payload may be maintained in conventional databases that are subject to modification or that are not readily accessible across platforms or jurisdictions. Establishing verifiable, cryptographically protected records of enforcement outcomes that can be validated by any participating platform remains an area of continuing interest.

Accordingly, there is general interest in computing infrastructure capable of generating, propagating, and enforcing machine-readable governance artifacts that bind a plurality of independent computing environments to a consistent authorization state, conditional execution constraints, and enforcement directives associated with a participating entity, and that support coordinated handling of digital payloads held in conditional holding states across synchronous, asynchronous, and distributed environments.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for governing conditional execution of operations across a plurality of independent computing environments is provided. The method comprises generating, by one or more processors, a machine-readable execution governance payload associated with a participating entity, the execution governance payload encapsulating (i) an authorization state of the participating entity, (ii) one or more conditional execution constraints applicable to the participating entity, and (iii) one or more enforcement directives. The method further comprises receiving, by the one or more processors, from a requesting platform of the plurality of independent computing environments, an execution request to release, transfer, or settle a digital payload held in a conditional holding state on behalf of the participating entity. The method further comprises evaluating, by the one or more processors, the execution request against the execution governance payload, and determining, in accordance with the one or more enforcement directives, an enforcement outcome that specifies whether release, transfer, or settlement of the held digital payload is to be permitted, restricted, or denied. The method further comprises enforcing, by the one or more processors, the enforcement outcome across the plurality of independent computing environments, including the requesting platform, by propagating the execution governance payload, as updated to reflect the enforcement outcome, to the plurality of independent computing environments as an authoritative execution condition that binds each of the plurality of independent computing environments to apply the enforcement outcome with respect to the held digital payload and to apply the authorization state, the conditional execution constraints, and the enforcement directives with respect to the participating entity across pending and subsequent execution requests.

According to other aspects of the present disclosure, the method may include one or more of the following features. The execution governance payload may be cryptographically signed and recorded on a distributed ledger network. The authorization state may be derived at least in part from an identity enforcement response received from an external identity infrastructure, the identity enforcement response comprising a machine-readable payload that includes enforcement directives associated with the participating entity. Evaluating the execution request may comprise evaluating the execution governance payload against an enforcement state vector received from an external legal execution infrastructure, the enforcement state vector encapsulating enforcement status of the participating entity. The one or more conditional execution constraints may comprise at least one of a delegated permission, a jurisdictional restriction, a compliance condition, or a behavioral restriction. The execution request may be initiated by an artificial-intelligence agent bound to the participating entity, and the one or more conditional execution constraints may constrain an execution authority of the artificial-intelligence agent relative to the participating entity. The held digital payload may be maintained in a programmable intermediary holding state pending satisfaction of a release condition, and the method may further comprise one or more of: transitioning the execution governance payload into a freeze state, a suspend state, or a revoke state; causing automatic expiration of the execution governance payload upon elapse of a temporal timeout; initiating a rollback that reverts a state of the held digital payload upon failure or invalidation; and invalidating a transient execution environment associated with the execution request following execution completion, rollback, or reversion. The method may further comprise receiving, by the one or more processors, from each of one or more of the plurality of independent computing environments, an acknowledgment signal confirming application of the enforcement outcome; evaluating, by the one or more processors, whether each acknowledgment signal is valid; upon determining that an acknowledgment signal is valid, recording, by the one or more processors, an enforcement state record corresponding to the acknowledgment signal; and upon determining that an acknowledgment signal is invalid, or upon expiration of a timeout period without receipt of the acknowledgment signal from a particular environment of the plurality of independent computing environments, initiating, by the one or more processors, a reconciliation process comprising retransmitting the execution governance payload, as updated to reflect the enforcement outcome, to the particular environment. The execution governance payload may include a monotonically increasing version identifier, and the method may further comprise propagating the version identifier with the execution governance payload such that each of the plurality of independent computing environments rejects, as stale, any execution governance payload bearing a version identifier earlier than a latest version identifier previously received for the participating entity. The method may further comprise causing each of the plurality of independent computing environments to cryptographically verify the cryptographic signature of the execution governance payload prior to applying the enforcement outcome, and to refuse to apply the enforcement outcome upon failure of verification. The release condition may comprise an event predicate evaluable against at least one of an external data source, an oracle input, a counterparty confirmation signal, or a time-based trigger, and release of the held digital payload to a designated recipient may be conditioned on satisfaction of the event predicate. The artificial-intelligence agent may be bound to the participating entity by a parent-identity reference encoded in the execution governance payload, a scope of the execution authority of the artificial-intelligence agent may be encoded in the execution governance payload, and operations of the artificial-intelligence agent may be revocable by updating the execution governance payload to remove or modify the scope.

According to another aspect of the present disclosure, a networked computing system for governing conditional execution of operations across a plurality of independent computing environments is provided. The networked computing system comprises one or more hardware processors and a non-transitory memory storing instructions that, when executed by the one or more hardware processors, cause the system to generate a machine-readable execution governance payload associated with a participating entity, the execution governance payload encapsulating (i) an authorization state of the participating entity, (ii) one or more conditional execution constraints applicable to the participating entity, and (iii) one or more enforcement directives. The instructions, when executed, further cause the system to receive, from a requesting platform of the plurality of independent computing environments, an execution request to release, transfer, or settle a digital payload held in a conditional holding state on behalf of the participating entity. The instructions, when executed, further cause the system to evaluate the execution request against the execution governance payload, and determine, in accordance with the one or more enforcement directives, an enforcement outcome that specifies whether release, transfer, or settlement of the held digital payload is to be permitted, restricted, or denied. The instructions, when executed, further cause the system to enforce the enforcement outcome across the plurality of independent computing environments, including the requesting platform, by propagating the execution governance payload, as updated to reflect the enforcement outcome, to the plurality of independent computing environments as an authoritative execution condition that binds each of the plurality of independent computing environments to apply the enforcement outcome with respect to the held digital payload and to apply the authorization state, the conditional execution constraints, and the enforcement directives with respect to the participating entity across pending and subsequent execution requests.

According to other aspects of the present disclosure, the networked computing system may include one or more of the following features. The execution governance payload may comprise a cryptographically signed, machine-readable data structure that is recorded on a distributed ledger network. The instructions may further cause the system to expose an application programming interface configured to permit a third-party platform of the plurality of independent computing environments to submit execution requests and to receive resulting enforcement outcomes specifying that release, transfer, or settlement of the held digital payload is permitted, restricted, or denied. The execution request may comprise a request to perform at least one of a transfer, a settlement, a release, an asset movement, a delegated action, or an operation initiated by an artificial-intelligence agent bound to the participating entity, with respect to the held digital payload. The one or more conditional execution constraints may include a jurisdictional restriction, and the instructions may further cause the system to evaluate a geographic parameter associated with the execution request against the jurisdictional restriction. The participating entity may be associated with a digital wallet account linked to an avatar or a virtual business entity, the execution request may comprise a request to perform at least one of a banking operation, an escrow operation, a loan issuance operation, or an insurance underwriting operation in respect of a virtual asset, and the instructions may further cause the system to enforce one or more terms of the execution request through execution of a smart contract deployed on a distributed ledger. The instructions may further cause the system to receive, from each of one or more of the plurality of independent computing environments, an acknowledgment signal confirming application of the enforcement outcome; evaluate whether each acknowledgment signal is valid; upon determining that an acknowledgment signal is valid, record an enforcement state record corresponding to the acknowledgment signal; and upon determining that an acknowledgment signal is invalid, or upon expiration of a timeout period without receipt of the acknowledgment signal from a particular environment of the plurality of independent computing environments, initiate a reconciliation process comprising retransmitting the execution governance payload, as updated to reflect the enforcement outcome, to the particular environment.

According to another aspect of the present disclosure, a computer program product is provided. The computer program product comprises a non-transitory computer-readable storage medium storing instructions that, when executed by one or more processors, cause the one or more processors to perform the method described above.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a system architecture of a CipherVault execution governance system and its operational environment, according to aspects of the present disclosure.

FIG. 2 illustrates an internal architecture of the CipherVault execution governance system of FIG. 1, according to aspects of the present disclosure.

FIG. 3 illustrates a data structure of an execution governance payload, according to aspects of the present disclosure.

FIG. 4 illustrates a state machine diagram depicting a lifecycle of a held digital payload, according to aspects of the present disclosure.

FIG. 5 illustrates a flowchart of a method for governing conditional execution of operations across a plurality of independent computing environments, according to aspects of the present disclosure.

FIG. 6 illustrates a sub-flowchart of an evaluation and outcome determination step of the method of FIG. 5, according to aspects of the present disclosure.

FIG. 7 illustrates a propagation, acknowledgment, and reconciliation workflow performed by the CipherVault execution governance system of FIG. 1, according to aspects of the present disclosure.

FIG. 8 illustrates a sequence diagram of an AI-agent-initiated settlement workflow, according to aspects of the present disclosure.

FIG. 9 illustrates a sequence diagram of a conditional release workflow for a held digital payload in response to an event predicate, according to aspects of the present disclosure.

FIG. 10 illustrates a sequence diagram of an enforcement state change propagation and reconciliation workflow, according to aspects of the present disclosure.

FIG. 11 illustrates a state machine diagram depicting a lifecycle of the execution governance payload of FIG. 3, according to aspects of the present disclosure.

FIG. 12 illustrates a conceptual architecture diagram showing a governance layer applied to execution rights across interoperable environments, according to aspects of the present disclosure.

FIG. 13 illustrates a commercial metaverse banking embodiment applied to a digital wallet account associated with an avatar or a virtual business entity, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

A detailed description of systems, devices, and methods consistent with embodiments of the present disclosure is provided below. While several embodiments are described, it should be understood that disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The present disclosure relates to a computing infrastructure that generates, propagates, and enforces a machine-readable governance artifact that binds a plurality of independent computing environments to a consistent authorization state, one or more conditional execution constraints, and one or more enforcement directives associated with a participating entity, including with respect to a digital payload held in a conditional holding state. In some aspects, the governance artifact may take the form of a structured, machine-readable execution governance payload that is generated by an execution governance system, distributed to each of the independent computing environments that may act on behalf of the participating entity, and treated by each of those environments as an authoritative execution condition governing whether a requested operation on the held digital payload is to be permitted, restricted, or denied.

In some aspects, the participating entity may be a human user, a business, an avatar or virtual business entity, an automated software agent, or an artificial-intelligence agent acting on behalf of any of the foregoing. In some aspects, the digital payload held in a conditional holding state may include funds, tokens, assets, entitlements, records, or other digital objects whose release, transfer, or settlement is deferred pending satisfaction of one or more conditions. In some aspects, the independent computing environments may include requesting platforms, settlement platforms, marketplace platforms, regulated exchange platforms, and one or more distributed ledger networks, each of which may be separately operated and may separately maintain operational state in respect of the participating entity.

A technical problem addressed by the present disclosure relates to inconsistent enforcement of authorization decisions, conditional constraints, and enforcement directives across such independent computing environments. In conventional arrangements, each environment tends to evaluate authorization locally based on credentials, tokens, or on-chain inputs visible to that environment, with the result that a change in the status of the participating entity, such as a suspension, a revocation of delegated authority, a compliance violation, a change in jurisdictional eligibility, or a freeze, expiration, or rollback applicable to a held digital payload, may be observed by one environment while remaining unobserved by another. Divergent enforcement states across independent environments can permit operations to proceed in one environment that are no longer authorized in another, can leave a held digital payload in incompatible states across environments, and can complicate auditability of authorization decisions and enforcement actions taken in respect of the participating entity.

In some aspects, the approach described in the present disclosure may coordinate authoritative execution conditions across independent computing environments by generating the execution governance payload from inputs that may include an identity enforcement response, an enforcement state vector, a compliance state signal, an event predicate, and one or more conditional execution constraints applicable to the participating entity, by evaluating an incoming execution request against the execution governance payload to determine an enforcement outcome, and by propagating the execution governance payload, as updated to reflect the enforcement outcome, to the independent computing environments such that each of those environments may apply the same authorization state, the same conditional execution constraints, and the same enforcement directives with respect to the participating entity across pending and subsequent execution requests. In some aspects, the execution governance payload may be cryptographically signed and may carry a version identifier, such that each environment may verify the authenticity of the payload before applying the enforcement outcome and may reject as stale any payload carrying an earlier version identifier than a latest payload previously received for the participating entity.

In some aspects, the coordination provided by the present disclosure may be operable across synchronous environments, in which a request and a response are exchanged in a tightly coupled interaction, asynchronous environments, in which operations are queued, deferred, or processed out of order, and distributed environments, in which operations are executed across multiple nodes that may individually observe partial state. In some aspects, an acknowledgment and reconciliation mechanism may be applied to confirm application of the execution governance payload at each environment, to record an enforcement state record corresponding to a valid acknowledgment, and to retransmit the execution governance payload to an environment from which a valid acknowledgment has not been received within a timeout period, such that a consistent enforcement state may be maintained across the independent computing environments notwithstanding differences in connectivity, processing latency, or operating mode. In some aspects, an enforcement state record corresponding to an enforcement outcome may be recorded on a distributed ledger network, such that a tamper-resistant record of authorization decisions and enforcement actions taken in respect of the participating entity and the held digital payload may be made available to participating platforms.

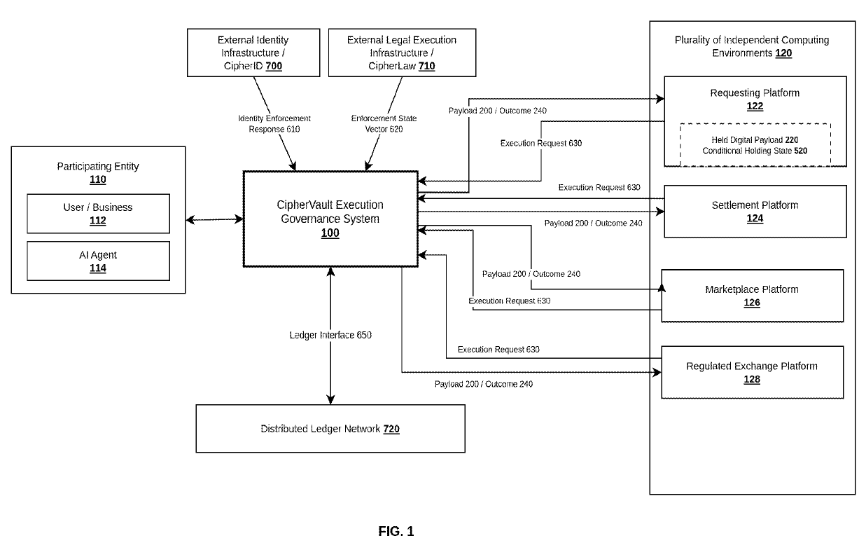

FIG. 1 illustrates a system architecture of a CipherVault execution governance system 100 and an operational environment of the CipherVault execution governance system 100, according to aspects of the present disclosure. In some aspects, the CipherVault execution governance system 100 may be implemented on one or more hardware processors and a non-transitory memory storing instructions that, when executed by the one or more hardware processors, cause the CipherVault execution governance system 100 to generate, propagate, and enforce a machine-readable execution governance payload across a plurality of independent computing environments, as described in further detail below.

In some aspects, the CipherVault execution governance system 100 may be communicatively coupled to a participating entity 110. In some aspects, the participating entity 110 may comprise a user / business 112, an AI agent 114, or a combination thereof. In some aspects, the user / business 112 may comprise a human user, a business, an avatar, or a virtual business entity associated with the user / business 112. In some aspects, the AI agent 114 may comprise an artificial-intelligence agent or another automated software agent acting on behalf of the user / business 112. In some aspects, the AI agent 114 may operate within an AI agent environment 130, which may comprise a runtime, container, or hosted computing environment in which the AI agent 114 executes and from which the AI agent 114 may initiate operations on behalf of the participating entity 110.

In some aspects, the CipherVault execution governance system 100 may be communicatively coupled to an external identity infrastructure / CipherID 700 and to an external legal execution infrastructure / CipherLaw 710. In some aspects, the external identity infrastructure / CipherID 700 may supply an identity enforcement response 610 to the CipherVault execution governance system 100. In some aspects, the identity enforcement response 610 may comprise a machine-readable payload that conveys an authorization state and associated enforcement directives applicable to the participating entity 110. In some aspects, the external legal execution infrastructure / CipherLaw 710 may supply an enforcement state vector 620 to the CipherVault execution governance system 100. In some aspects, the enforcement state vector 620 may encapsulate an enforcement status of the participating entity 110, such as a regulatory, jurisdictional, or compliance-related status applicable to operations initiated by or on behalf of the participating entity 110.

In some aspects, the CipherVault execution governance system 100 may interface with a plurality of independent computing environments 120. In some aspects, the plurality of independent computing environments 120 may comprise a requesting platform 122, a settlement platform 124, a marketplace platform 126, and a regulated exchange platform 128. In some aspects, each platform of the plurality of independent computing environments 120 may be separately operated and may separately maintain operational state in respect of the participating entity 110.

In some aspects, each platform of the plurality of independent computing environments 120 may issue an execution request 630 to the CipherVault execution governance system 100. In some aspects, the execution request 630 may comprise a request, received by the one or more hardware processors of the CipherVault execution governance system 100 from the requesting platform 122 of the plurality of independent computing environments 120, to release, transfer, or settle a held digital payload 220 on behalf of the participating entity 110. In some aspects, the held digital payload 220 may reside within the requesting platform 122 in a conditional holding state 520, in which release, transfer, or settlement of the held digital payload 220 is deferred pending satisfaction of one or more conditions specified by an execution governance payload 200.

In some aspects, in response to the execution request 630, the CipherVault execution governance system 100 may return, to the issuing platform of the plurality of independent computing environments 120, the execution governance payload 200 and an enforcement outcome 240. In some aspects, the execution governance payload 200 may comprise a machine-readable governance artifact associated with the participating entity 110 that encapsulates an authorization state of the participating entity 110, one or more conditional execution constraints applicable to the participating entity 110, and one or more enforcement directives. In some aspects, the enforcement outcome 240 may specify whether release, transfer, or settlement of the held digital payload 220 is to be permitted, restricted, or denied.

In some aspects, the CipherVault execution governance system 100 may enforce the enforcement outcome 240 across the plurality of independent computing environments 120, including the requesting platform 122, by propagating the execution governance payload 200, as updated to reflect the enforcement outcome 240, to each of the requesting platform 122, the settlement platform 124, the marketplace platform 126, and the regulated exchange platform 128 as an authoritative execution condition. In some aspects, each of the plurality of independent computing environments 120 may, upon receipt of the execution governance payload 200, apply the enforcement outcome 240 with respect to the held digital payload 220 and may apply the authorization state, the conditional execution constraints, and the enforcement directives with respect to the participating entity 110 across pending and subsequent execution requests.

In some aspects, the CipherVault execution governance system 100 may be coupled to a distributed ledger network 720 via a ledger interface 650. In some aspects, the ledger interface 650 may comprise a communication channel through which the CipherVault execution governance system 100 may record, on the distributed ledger network 720, an enforcement state record corresponding to the enforcement outcome 240, such that a tamper-resistant record of authorization decisions and enforcement actions taken in respect of the participating entity 110 and the held digital payload 220 may be made available to the plurality of independent computing environments 120.

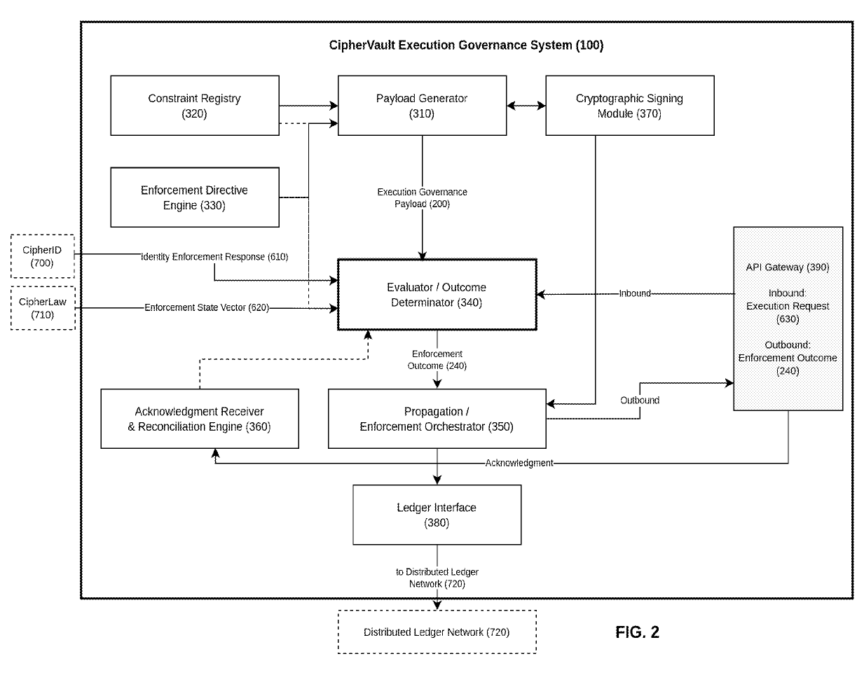

FIG. 2 illustrates an internal architecture of the CipherVault execution governance system 100, according to aspects of the present disclosure. In some aspects, the CipherVault execution governance system 100 may comprise a plurality of internal modules cooperatively configured to generate, sign, evaluate, propagate, reconcile, and record the execution governance payload 200. In some aspects, the internal modules may comprise a payload generator 310, a constraint registry 320, an enforcement directive engine 330, an evaluator / outcome determinator 340, a propagation / enforcement orchestrator 350, an acknowledgment receiver & reconciliation engine 360, a cryptographic signing module 370, a ledger interface 380, and an API gateway 390.

In some aspects, the constraint registry 320 may store and supply the one or more conditional execution constraints applicable to the participating entity 110, including one or more of a delegated permission, a jurisdictional restriction, a compliance condition, or a behavioral restriction. In some aspects, the enforcement directive engine 330 may store and supply the one or more enforcement directives applicable to the participating entity 110, including one or more directives that cause a freeze, suspension, revocation, expiration, or rollback to be applied with respect to the held digital payload 220 or the execution governance payload 200. In some aspects, the constraint registry 320 and the enforcement directive engine 330 may each supply a respective input to the payload generator 310.

In some aspects, the payload generator 310 may receive the conditional execution constraints from the constraint registry 320 and the enforcement directives from the enforcement directive engine 330, and may assemble the execution governance payload 200 as a machine-readable governance artifact associated with the participating entity 110 that encapsulates the authorization state, the conditional execution constraints, and the enforcement directives. In some aspects, the payload generator 310 may exchange signing operations with the cryptographic signing module 370 over a bidirectional connection, such that the cryptographic signing module 370 may apply a cryptographic signature to the execution governance payload 200. In some aspects, the cryptographic signature applied by the cryptographic signing module 370 may permit each of the plurality of independent computing environments 120 to verify authenticity and integrity of the execution governance payload 200 prior to application of the enforcement outcome 240.

In some aspects, the payload generator 310 may forward the execution governance payload 200 to the evaluator / outcome determinator 340. In some aspects, the evaluator / outcome determinator 340 may additionally receive a constraint input from the constraint registry 320 and a directive input from the enforcement directive engine 330. In some aspects, the evaluator / outcome determinator 340 may further receive the identity enforcement response 610 from the external identity infrastructure / CipherID 700 and the enforcement state vector 620 from the external legal execution infrastructure / CipherLaw 710. In some aspects, the evaluator / outcome determinator 340 may evaluate an incoming execution request 630 against the execution governance payload 200 in light of the identity enforcement response 610, the enforcement state vector 620, the conditional execution constraints supplied by the constraint registry 320, and the enforcement directives supplied by the enforcement directive engine 330, and may determine the enforcement outcome 240 specifying whether release, transfer, or settlement of the held digital payload 220 is to be permitted, restricted, or denied.

In some aspects, the evaluator / outcome determinator 340 may forward the enforcement outcome 240 to the propagation / enforcement orchestrator 350. In some aspects, the cryptographic signing module 370 may further provide a downward connection to the propagation / enforcement orchestrator 350, such that the execution governance payload 200, as updated to reflect the enforcement outcome 240, may be cryptographically signed prior to outbound transmission. In some aspects, the propagation / enforcement orchestrator 350 may transmit the execution governance payload 200, as updated to reflect the enforcement outcome 240, outward to the plurality of independent computing environments 120 as an authoritative execution condition that binds each of the plurality of independent computing environments 120 to apply the authorization state, the conditional execution constraints, and the enforcement directives with respect to the participating entity 110.

In some aspects, the propagation / enforcement orchestrator 350 may provide an outbound connection to the API gateway 390. In some aspects, the API gateway 390 may expose an inbound endpoint configured to receive the execution request 630 from the plurality of independent computing environments 120, and an outbound endpoint configured to return the enforcement outcome 240 to the plurality of independent computing environments 120. In some aspects, the API gateway 390 may route inbound traffic carrying the execution request 630 to the evaluator / outcome determinator 340 for evaluation. In some aspects, the API gateway 390 may further forward acknowledgments received from the plurality of independent computing environments 120 to the acknowledgment receiver & reconciliation engine 360.

In some aspects, the API gateway 390 may be configured to permit third-party platforms of the plurality of independent computing environments 120, including immersive platforms such as virtual-world platforms, metaverse platforms, and augmented-reality or virtual-reality platforms, to embed banking modules and escrow modules supplied by the CipherVault execution governance system 100 natively within environments of the third-party platforms. In some aspects, the API gateway 390 may expose a set of programmatic interfaces through which a third-party requesting platform 122 may invoke functionality of the CipherVault execution governance system 100, including submission of the execution request 630 with respect to the held digital payload 220 and receipt of the enforcement outcome 240 and the execution governance payload 200, such that banking operations, escrow operations, and related governed operations may be initiated, evaluated, and enforced from within a native interface of the third-party platform without redirection to an external interface of the CipherVault execution governance system 100.

In some aspects, the acknowledgment receiver & reconciliation engine 360 may receive, via the API gateway 390, an acknowledgment signal returned by each of one or more of the plurality of independent computing environments 120 to confirm application of the enforcement outcome 240 at the corresponding environment. In some aspects, the acknowledgment receiver & reconciliation engine 360 may evaluate whether each acknowledgment signal is valid, and may signal the evaluator / outcome determinator 340 along a reconciliation path to indicate validity, invalidity, or absence of an acknowledgment signal. In some aspects, upon determining that an acknowledgment signal is invalid or that no acknowledgment signal has been received from a particular environment of the plurality of independent computing environments 120 within a timeout period, the acknowledgment receiver & reconciliation engine 360 may trigger a reconciliation process that causes the execution governance payload 200, as updated to reflect the enforcement outcome 240, to be retransmitted to the particular environment via the propagation / enforcement orchestrator 350.

In some aspects, the propagation / enforcement orchestrator 350 may further write to the ledger interface 380. In some aspects, the ledger interface 380 may record an enforcement state record corresponding to the enforcement outcome 240 on the distributed ledger network 720, such that a tamper-resistant record of authorization decisions and enforcement actions taken with respect to the participating entity 110 and the held digital payload 220 may be made available to the plurality of independent computing environments 120. In some aspects, the external identity infrastructure / CipherID 700, the external legal execution infrastructure / CipherLaw 710, and the distributed ledger network 720 may reside externally to the CipherVault execution governance system 100 and may interface with the internal modules of the CipherVault execution governance system 100 as described above.

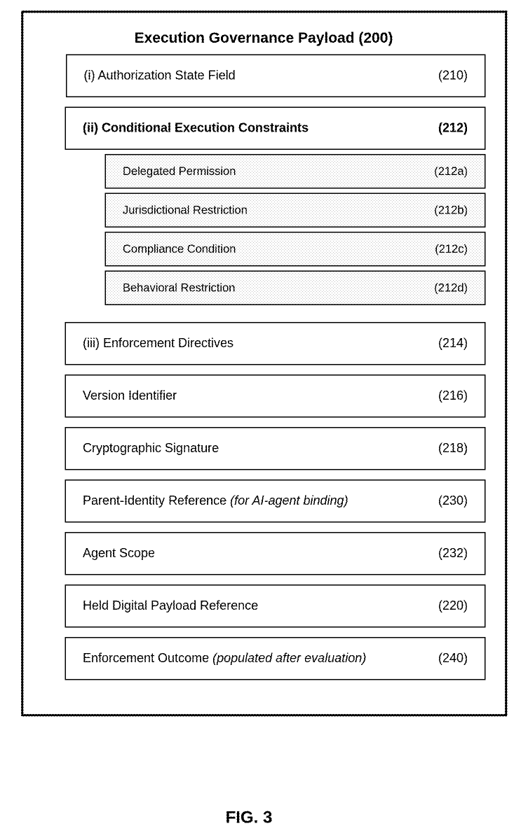

FIG. 3 illustrates a data structure of the execution governance payload 200, according to aspects of the present disclosure. In some aspects, the execution governance payload 200 may comprise a machine-readable governance artifact associated with the participating entity 110 that encapsulates an authorization state of the participating entity 110, one or more conditional execution constraints applicable to the participating entity 110, and one or more enforcement directives. In some aspects, the execution governance payload 200 may be assembled by the payload generator 310 and may be expressed in a structured serialization format suitable for cryptographic signing, propagation, and parsing by each of the plurality of independent computing environments 120.

In some aspects, the execution governance payload 200 may encapsulate, in order, (i) an authorization state field 210, (ii) conditional execution constraints 212, and (iii) enforcement directives 214, followed by a version identifier 216, a cryptographic signature 218, a parent-identity reference 230, an agent scope 232, a reference to the held digital payload 220, and the enforcement outcome 240.

In some aspects, the authorization state field 210 may encode the authorization state of the participating entity 110 as carried by the execution governance payload 200. In some aspects, the authorization state field 210 may indicate whether the participating entity 110 is in an active authorization state, a restricted authorization state, or an inactive authorization state, and may be derived at least in part from the identity enforcement response 610 received from the external identity infrastructure / CipherID 700.

In some aspects, the conditional execution constraints 212 may comprise a structured field that aggregates the one or more conditional execution constraints applicable to the participating entity 110. In some aspects, the conditional execution constraints 212 may comprise a delegated permission 212a, a jurisdictional restriction 212b, a compliance condition 212c, and a behavioral restriction 212d, each nested as a sub-field of the conditional execution constraints 212.

In some aspects, the delegated permission 212a may encode a scope of authority that has been delegated by the participating entity 110 to another actor, such as an AI agent 114 or a designated user, and may specify operations that the delegated actor is authorized to initiate with respect to the held digital payload 220. In some aspects, the jurisdictional restriction 212b may encode a geographic or jurisdictional limitation on operations initiated by or on behalf of the participating entity 110, such that an execution request 630 originating from, or affecting assets located in, a non-permitted jurisdiction may be restricted or denied. In some aspects, the compliance condition 212c may encode a regulatory or policy condition that is evaluated against the execution request 630, such as a know-your-customer status, an anti-money-laundering condition, a sanctions condition, or another regulatory condition applicable to the participating entity 110. In some aspects, the behavioral restriction 212d may encode a behavioral limitation applicable to operations initiated by or on behalf of the participating entity 110, such as a transaction frequency limit, a transaction amount limit, a permitted-counterparty restriction, or a permitted-operation restriction.

In some aspects, the enforcement directives 214 may encode the one or more enforcement directives associated with the participating entity 110, including one or more directives that cause a freeze, suspension, revocation, expiration, or rollback to be applied with respect to the held digital payload 220 or the execution governance payload 200. In some aspects, the enforcement directives 214 may be derived at least in part from the enforcement directive engine 330 and may be invoked by the evaluator / outcome determinator 340 in determining the enforcement outcome 240.

In some aspects, the version identifier 216 may comprise a monotonically increasing identifier that distinguishes successive instances of the execution governance payload 200 associated with the participating entity 110. In some aspects, the version identifier 216 may be incremented each time the execution governance payload 200 is updated, such that each of the plurality of independent computing environments 120 may reject, as stale, any execution governance payload 200 bearing a version identifier 216 earlier than a latest version identifier 216 previously received for the participating entity 110.

In some aspects, the cryptographic signature 218 may comprise a digital signature applied to the execution governance payload 200 by the cryptographic signing module 370. In some aspects, the cryptographic signature 218 may permit each of the plurality of independent computing environments 120 to verify authenticity and integrity of the execution governance payload 200 prior to application of the enforcement outcome 240, and to refuse to apply the enforcement outcome 240 upon failure of verification.

In some aspects, the parent-identity reference 230 may comprise a binding field that ties the execution governance payload 200 to the participating entity 110 for AI-agent binding. In some aspects, the parent-identity reference 230 may identify the user / business 112 on whose behalf the AI agent 114 acts, such that operations initiated by the AI agent 114 may be evaluated against constraints and directives associated with the user / business 112. In some aspects, the agent scope 232 may encode a scope of execution authority granted to the AI agent 114, including operations that the AI agent 114 is authorized to initiate, classes of assets that the AI agent 114 is permitted to act upon, and limits on the AI agent 114. In some aspects, the agent scope 232 may be revocable or modifiable by updating the execution governance payload 200 to remove or modify the agent scope 232, and propagating the updated execution governance payload 200 to the plurality of independent computing environments 120.

In some aspects, the execution governance payload 200 may include a reference to the held digital payload 220 to which the execution governance payload 200 applies. In some aspects, the reference to the held digital payload 220 may identify the held digital payload 220 maintained in the conditional holding state 520 within the requesting platform 122, such that the plurality of independent computing environments 120 may apply the authorization state field 210, the conditional execution constraints 212, and the enforcement directives 214 with respect to the identified held digital payload 220.

In some aspects, the enforcement outcome 240 may be populated within the execution governance payload 200 after evaluation of an execution request 630 by the evaluator / outcome determinator 340. In some aspects, the enforcement outcome 240 may specify whether release, transfer, or settlement of the held digital payload 220 is to be permitted, restricted, or denied, and may be propagated, as part of the execution governance payload 200, to the plurality of independent computing environments 120 as an authoritative execution condition.

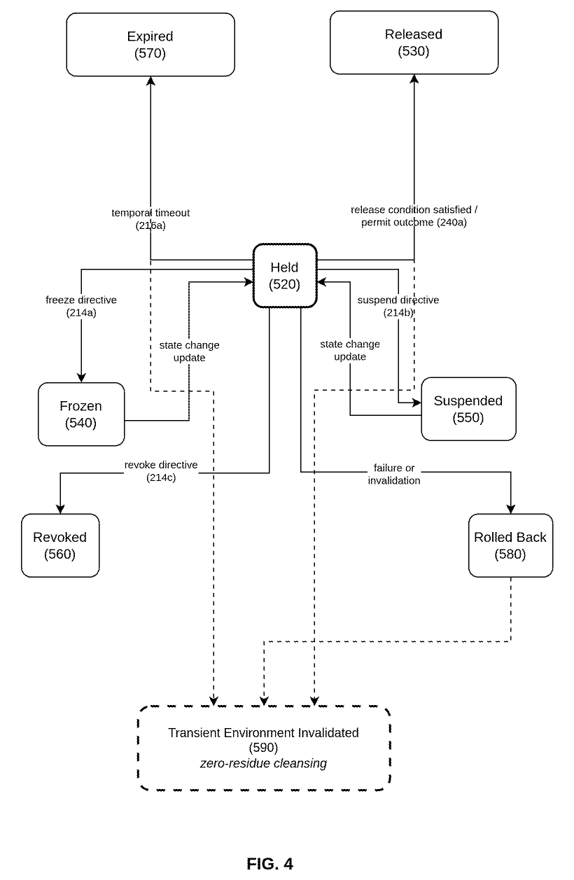

FIG. 4 illustrates a state machine diagram depicting a lifecycle of the held digital payload 220 governed by the execution governance payload 200, according to aspects of the present disclosure. In some aspects, the held digital payload 220 may be maintained in a programmable intermediary holding state pending satisfaction of a release condition, and the programmable intermediary holding state may correspond to the conditional holding state 520 from which transitions to other states of the lifecycle originate. In some aspects, the programmable intermediary holding state may be implemented as a programmable escrow container that holds the held digital payload 220 pending satisfaction of the release condition, the programmable escrow container being instantiable by the CipherVault execution governance system 100 on a per-execution request 630 basis and being parameterizable by the conditional execution constraints 212 and the enforcement directives 214 encoded in the execution governance payload 200. In some aspects, the programmable intermediary holding state may be operable to defer release, transfer, or settlement of the held digital payload 220 pending satisfaction of asynchronous execution conditions, including release conditions evaluated against asynchronous event signals, deferred counterparty confirmation signals, and event predicates 224 whose satisfaction is not known synchronously with the execution request 630, such that the programmable intermediary holding state supports operations executing within the asynchronous environment 890 and the distributed environment 892 in addition to the synchronous environment 880.

In some aspects, the conditional holding state 520 may serve as a central state of the lifecycle in which release, transfer, or settlement of the held digital payload 220 is deferred pending evaluation of the execution request 630 against the execution governance payload 200 and satisfaction of one or more conditions specified by the execution governance payload 200. In some aspects, while the held digital payload 220 resides in the conditional holding state 520, the authorization state field 210, the conditional execution constraints 212, and the enforcement directives 214 of the execution governance payload 200 may continue to bind the plurality of independent computing environments 120 with respect to the held digital payload 220.

In some aspects, the held digital payload 220 may transition from the conditional holding state 520 to a released 530 state upon satisfaction of the release condition together with a permit outcome 240a determined by the evaluator / outcome determinator 340. In some aspects, upon entry into the released 530 state, release, transfer, or settlement of the held digital payload 220 may be effectuated at the requesting platform 122 in accordance with the enforcement outcome 240 carried by the execution governance payload 200.

In some aspects, the held digital payload 220 may transition from the conditional holding state 520 to an expired 570 state upon elapse of a temporal timeout 216a. In some aspects, the temporal timeout 216a may cause automatic expiration of the execution governance payload 200 upon elapse of a temporal interval associated with the execution governance payload 200, such that the held digital payload 220 may be transitioned out of the conditional holding state 520 without further evaluation of the execution request 630. In some aspects, the temporal timeout 216a may operate as an autonomous execution expiration protocol that prevents indefinite suspension of transactions, escrow states, or conditional asset payloads associated with the participating entity 110, such that the held digital payload 220 cannot remain in the conditional holding state 520, the frozen 540 state, or the suspended 550 state indefinitely in the absence of a release condition being satisfied or a state-change update being applied to the execution governance payload 200.

In some aspects, the held digital payload 220 may transition from the conditional holding state 520 to a frozen 540 state in response to a freeze directive 214a carried by the enforcement directives 214. In some aspects, the held digital payload 220 may transition from the conditional holding state 520 to a suspended 550 state in response to a suspend directive 214b carried by the enforcement directives 214. In some aspects, the freeze directive 214a and the suspend directive 214b may transition the execution governance payload 200 into a freeze state and a suspend state, respectively, such that release, transfer, or settlement of the held digital payload 220 is paused at each of the plurality of independent computing environments 120 while the freeze directive 214a or the suspend directive 214b is in effect.

In some aspects, the frozen 540 state and the suspended 550 state may each return to the conditional holding state 520 upon a state-change update applied to the execution governance payload 200. In some aspects, the state-change update may comprise an updated identity enforcement response 610, an updated enforcement state vector 620, or a clearance of the freeze directive 214a or the suspend directive 214b by the enforcement directive engine 330, such that the held digital payload 220 may resume residence in the conditional holding state 520 pending satisfaction of the release condition.

In some aspects, the held digital payload 220 may transition from the conditional holding state 520 to a revoked 560 state in response to a revoke directive 214c carried by the enforcement directives 214. In some aspects, the revoke directive 214c may transition the execution governance payload 200 into a revoke state, such that the authority to release, transfer, or settle the held digital payload 220 is withdrawn from the plurality of independent computing environments 120.

In some aspects, the held digital payload 220 may transition from the conditional holding state 520 to a rolled back 580 state upon a failure or invalidation associated with the execution request 630 or the held digital payload 220. In some aspects, entry into the rolled back 580 state may initiate a rollback that reverts a state of the held digital payload 220 to a prior state, such that effects of an incomplete or invalidated operation on the held digital payload 220 may be reversed.

In some aspects, the released 530 state, the expired 570 state, and the rolled back 580 state may each transition to a transient environment invalidated 590 state. In some aspects, the transient environment invalidated 590 state may comprise a terminal state of the lifecycle in which a transient execution environment associated with the execution request 630 is invalidated following execution completion, rollback, or reversion. In some aspects, invalidation of the transient execution environment may comprise a zero-residue cleansing of the transient execution environment associated with the held digital payload 220, in which ephemeral state, intermediate computation artifacts, and cached credentials associated with the execution request 630 are cleared from the transient execution environment.

In some aspects, the transient execution environment associated with the execution request 630 may be instantiated by the CipherVault execution governance system 100 on a per-execution-request basis and may comprise one or more of an operating-system-level container, a sandboxed process, a hardware-isolated enclave, a virtual machine, an ephemeral runtime instance, an isolated namespace, or a scoped memory region allocated for evaluation, propagation, or application of the execution governance payload 200 with respect to the held digital payload 220. In some aspects, the transient execution environment may be identified by a transient environment identifier bound to the execution request 630, to the version identifier 216 of the execution governance payload 200, or to a combination thereof, such that the transient execution environment may be located and addressed for invalidation across the plurality of independent computing environments 120 notwithstanding differences in underlying runtime, orchestration platform, or operating mode. In some aspects, invalidation of the transient execution environment as the transient environment invalidated 590 state may be effectuated by one or more teardown procedures appropriate to the manner in which the transient execution environment was instantiated, including one or more of: destruction of a container or sandbox instance by way of a container-runtime teardown call; termination of an ephemeral process or virtual machine instance; deallocation and zeroization of memory regions allocated to the transient execution environment such that residual contents of the memory regions are overwritten prior to release; flushing of a credential cache and destruction of ephemeral cryptographic keys associated with the execution request 630; revocation or expiry of short-lived authorization tokens issued in respect of the execution request 630; closure and decommissioning of network endpoints, sockets, or session handles allocated to the transient execution environment; and removal of intermediate computation artifacts and temporary files associated with the execution request 630 from persistent or semi-persistent storage. In some aspects, the teardown procedures may be invoked uniformly across heterogeneous environments of the plurality of independent computing environments 120 by way of a teardown directive carried by the enforcement directives 214 of the execution governance payload 200 or signaled to the corresponding one of the plurality of independent computing environments 120 through the propagation 660, such that each of the synchronous environment 880, the asynchronous environment 890, and the distributed environment 892 may apply the teardown procedures appropriate to the transient execution environment instantiated at that environment. In some aspects, completion of the teardown procedures at a corresponding one of the plurality of independent computing environments 120 may be attested by an acknowledgment signal 640 returned to the acknowledgment receiver & reconciliation engine 360, such that completion of invalidation of the transient execution environment may be reconciled across the plurality of independent computing environments 120 and recorded as an enforcement state record 242 on the distributed ledger network 720.

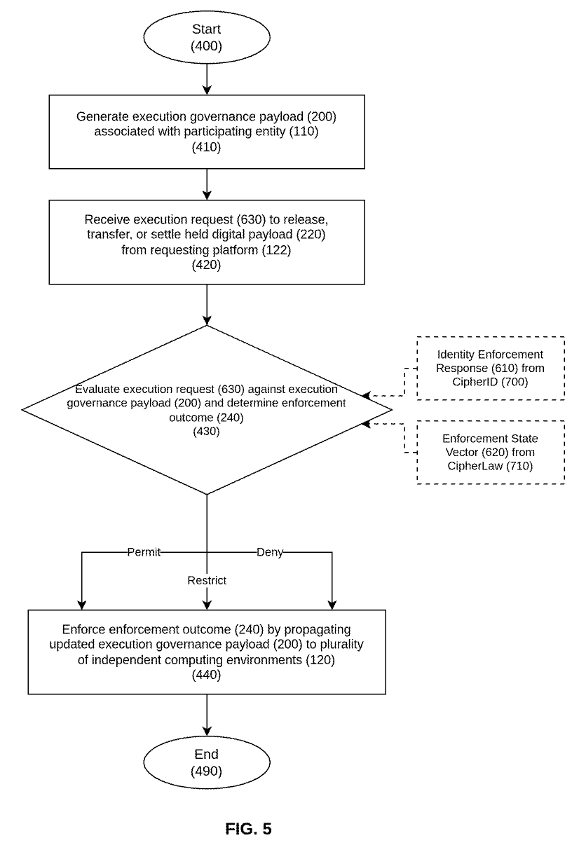

FIG. 5 illustrates a flowchart of a method 400 for governing conditional execution of operations across the plurality of independent computing environments 120, according to aspects of the present disclosure. In some aspects, the method 400 may be performed by one or more processors of the CipherVault execution governance system 100 and may coordinate generation, evaluation, and propagation of the execution governance payload 200 across the plurality of independent computing environments 120 with respect to the held digital payload 220.

In some aspects, the method 400 may begin at a start node and may proceed to a step 410. In some aspects, at the step 410, the one or more processors may generate a machine-readable execution governance payload 200 associated with the participating entity 110. In some aspects, the execution governance payload 200 generated at the step 410 may encapsulate (i) an authorization state of the participating entity 110, as encoded in the authorization state field 210, (ii) one or more conditional execution constraints applicable to the participating entity 110, as aggregated within the conditional execution constraints 212, and (iii) one or more enforcement directives, as encoded in the enforcement directives 214. In some aspects, the execution governance payload 200 generated at the step 410 may be cryptographically signed by the cryptographic signing module 370 and may carry the version identifier 216, such that the execution governance payload 200 may be authenticated and ordered relative to prior instances of the execution governance payload 200 associated with the participating entity 110.

In some aspects, the method 400 may then proceed from the step 410 to a step 420. In some aspects, at the step 420, the one or more processors may receive, from the requesting platform 122 of the plurality of independent computing environments 120, an execution request 630 to release, transfer, or settle the held digital payload 220 on behalf of the participating entity 110. In some aspects, the held digital payload 220 referenced by the execution request 630 received at the step 420 may reside within the requesting platform 122 in the conditional holding state 520, in which release, transfer, or settlement of the held digital payload 220 is deferred pending evaluation of the execution request 630 against the execution governance payload 200.

In some aspects, the method 400 may then proceed from the step 420 to a step 430. In some aspects, at the step 430, the one or more processors may evaluate the execution request 630 against the execution governance payload 200 and may determine, in accordance with the one or more enforcement directives encoded in the enforcement directives 214, an enforcement outcome 240 that specifies whether release, transfer, or settlement of the held digital payload 220 is to be permitted, restricted, or denied. In some aspects, the step 430 may additionally receive, as inputs to the evaluation, the identity enforcement response 610 supplied by the external identity infrastructure / CipherID 700 and the enforcement state vector 620 supplied by the external legal execution infrastructure / CipherLaw 710. In some aspects, the identity enforcement response 610 received at the step 430 may convey an authorization state and associated enforcement directives applicable to the participating entity 110, and the enforcement state vector 620 received at the step 430 may convey an enforcement status of the participating entity 110 applicable to operations initiated by or on behalf of the participating entity 110.

In some aspects, the step 430 may have three exit branches corresponding to the enforcement outcome 240 determined by the one or more processors, comprising a Permit branch, a Restrict branch, and a Deny branch. In some aspects, the Permit branch may be taken when the execution request 630 satisfies the authorization state field 210, the conditional execution constraints 212, and the enforcement directives 214 encoded in the execution governance payload 200, such that release, transfer, or settlement of the held digital payload 220 is permitted. In some aspects, the Restrict branch may be taken when one or more of the conditional execution constraints 212 are not satisfied, such that release, transfer, or settlement of the held digital payload 220 is permitted on a limited basis or subject to further conditions. In some aspects, the Deny branch may be taken when the authorization state field 210 indicates an inactive authorization state or when one or more of the enforcement directives 214 preclude execution, such that release, transfer, or settlement of the held digital payload 220 is denied.

In some aspects, each of the Permit branch, the Restrict branch, and the Deny branch of the step 430 may proceed to a step 440. In some aspects, at the step 440, the one or more processors may enforce the enforcement outcome 240 across the plurality of independent computing environments 120, including the requesting platform 122, by propagating the execution governance payload 200, as updated to reflect the enforcement outcome 240, to the plurality of independent computing environments 120 as an authoritative execution condition. In some aspects, the authoritative execution condition propagated at the step 440 may bind each of the plurality of independent computing environments 120 to apply the enforcement outcome 240 with respect to the held digital payload 220, and to apply the authorization state, the conditional execution constraints, and the enforcement directives with respect to the participating entity 110 across pending and subsequent execution requests. In some aspects, propagation of the execution governance payload 200 at the step 440 may include incrementing the version identifier 216 to distinguish the updated execution governance payload 200 from prior instances, and applying the cryptographic signature 218 to the updated execution governance payload 200 such that each of the plurality of independent computing environments 120 may verify the authenticity and integrity of the updated execution governance payload 200 prior to application of the enforcement outcome 240.

In some aspects, the method 400 may then proceed from the step 440 to an end node 490, at which the method 400 terminates with respect to the received execution request 630.

In some aspects, the method 400 described with reference to FIG. 5 may be embodied as a computer program product comprising a non-transitory computer-readable storage medium storing processor-executable instructions that, when executed by the one or more processors, cause the one or more processors to perform the method 400. In some aspects, the non-transitory computer-readable storage medium may comprise any of the storage media described elsewhere in the present disclosure suitable for storing the processor-executable instructions corresponding to the step 410, the step 420, the step 430, and the step 440 of the method 400.

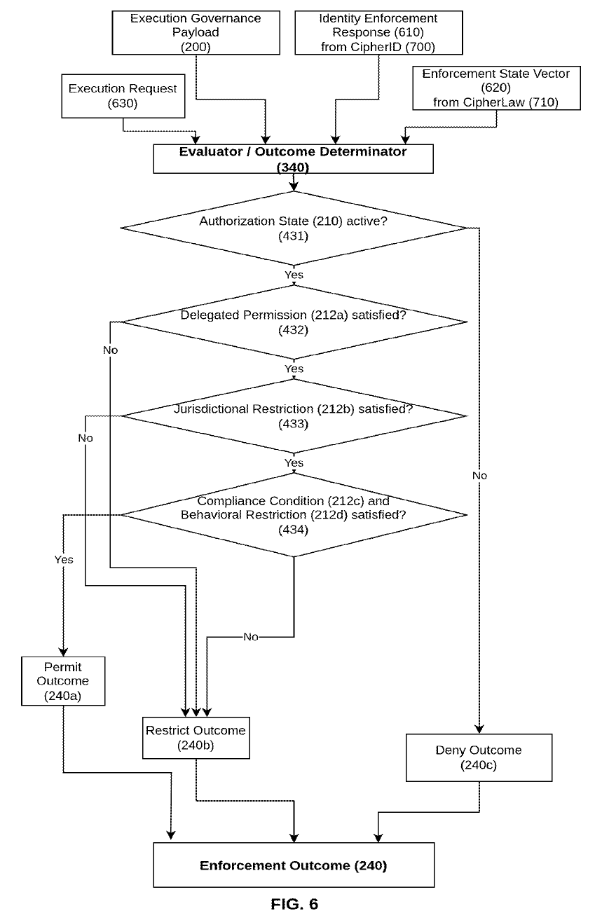

FIG. 6 illustrates a sub-flowchart expanding the step 430 of the method 400, depicting evaluation and outcome determination performed by the evaluator / outcome determinator 340, according to aspects of the present disclosure. In some aspects, the evaluator / outcome determinator 340 may receive four inputs at the top of the sub-flowchart and may proceed through a vertical chain of constraint-check decisions that produces the enforcement outcome 240.

In some aspects, a first input to the evaluator / outcome determinator 340 may comprise the execution request 630 received from the requesting platform 122 of the plurality of independent computing environments 120 to release, transfer, or settle the held digital payload 220 on behalf of the participating entity 110. In some aspects, a second input to the evaluator / outcome determinator 340 may comprise the execution governance payload 200 associated with the participating entity 110, encapsulating the authorization state field 210, the conditional execution constraints 212, and the enforcement directives 214 against which the execution request 630 is to be evaluated. In some aspects, a third input to the evaluator / outcome determinator 340 may comprise the identity enforcement response 610 received from the external identity infrastructure / CipherID 700, the identity enforcement response 610 comprising a machine-readable payload that includes enforcement directives associated with the participating entity 110, and from which the authorization state encoded in the authorization state field 210 may be derived at least in part. In some aspects, a fourth input to the evaluator / outcome determinator 340 may comprise the enforcement state vector 620 received from the external legal execution infrastructure / CipherLaw 710, the enforcement state vector 620 encapsulating an enforcement status of the participating entity 110, such that evaluation of the execution request 630 by the evaluator / outcome determinator 340 may comprise evaluating the execution governance payload 200 against the enforcement state vector 620.

In some aspects, the evaluator / outcome determinator 340 may proceed through a sequential chain of constraint-check decisions comprising a step 431, a step 432, a step 433, and a step 434, each of which evaluates a respective field of the execution governance payload 200 against the execution request 630, the identity enforcement response 610, and the enforcement state vector 620. In some aspects, the chain of constraint-check decisions may produce one of a permit outcome 240a, a restrict outcome 240b, or a deny outcome 240c, each of which feeds into the enforcement outcome 240 that constitutes the final output of the evaluator / outcome determinator 340.

In some aspects, at the step 431, the evaluator / outcome determinator 340 may determine whether the authorization state field 210 is active with respect to the participating entity 110. In some aspects, a Yes branch of the step 431 may proceed downward to the step 432, and a No branch of the step 431 may route to the deny outcome 240c such that release, transfer, or settlement of the held digital payload 220 is denied. In some aspects, the No branch of the step 431 may be taken when the authorization state field 210, as derived at least in part from the identity enforcement response 610 received from the external identity infrastructure / CipherID 700, indicates a restricted authorization state or an inactive authorization state for the participating entity 110.

In some aspects, at the step 432, the evaluator / outcome determinator 340 may determine whether the delegated permission 212a encoded as a sub-field of the conditional execution constraints 212 is satisfied by the execution request 630. In some aspects, a Yes branch of the step 432 may proceed downward to the step 433, and a No branch of the step 432 may route to the restrict outcome 240b such that release, transfer, or settlement of the held digital payload 220 is permitted on a limited basis or subject to further conditions. In some aspects, the No branch of the step 432 may be taken when the execution request 630 falls outside a scope of authority delegated by the participating entity 110, including outside a scope of authority delegated to an AI agent 114 acting on behalf of the participating entity 110.

In some aspects, at the step 433, the evaluator / outcome determinator 340 may determine whether the jurisdictional restriction 212b encoded as a sub-field of the conditional execution constraints 212 is satisfied by the execution request 630. In some aspects, the step 433 may comprise evaluating a geographic parameter associated with the execution request 630 against the jurisdictional restriction 212b, the geographic parameter comprising one or more of an origin location of the execution request 630, a jurisdiction associated with the participating entity 110, or a jurisdiction associated with assets affected by the execution request 630. In some aspects, a Yes branch of the step 433 may proceed downward to the step 434, and a No branch of the step 433 may route to the restrict outcome 240b such that release, transfer, or settlement of the held digital payload 220 is permitted on a limited basis or subject to further conditions when the geographic parameter does not satisfy the jurisdictional restriction 212b.

In some aspects, at the step 434, the evaluator / outcome determinator 340 may determine whether the compliance condition 212c and the behavioral restriction 212d encoded as sub-fields of the conditional execution constraints 212 are satisfied by the execution request 630. In some aspects, the step 434 may evaluate the compliance condition 212c against the enforcement state vector 620 received from the external legal execution infrastructure / CipherLaw 710, including against a regulatory, jurisdictional, or compliance-related status applicable to operations initiated by or on behalf of the participating entity 110. In some aspects, the step 434 may further evaluate the behavioral restriction 212d against one or more behavioral parameters associated with the execution request 630, including a transaction frequency, a transaction amount, a counterparty identity, or an operation type. In some aspects, a Yes branch of the step 434 may route to the permit outcome 240a such that release, transfer, or settlement of the held digital payload 220 is permitted, and a No branch of the step 434 may route to the restrict outcome 240b such that release, transfer, or settlement of the held digital payload 220 is permitted on a limited basis or subject to further conditions.

In some aspects, the permit outcome 240a, the restrict outcome 240b, and the deny outcome 240c may each feed into the enforcement outcome 240 produced by the evaluator / outcome determinator 340. In some aspects, the enforcement outcome 240 produced by the chain of constraint-check decisions may be populated within the execution governance payload 200 and propagated to the plurality of independent computing environments 120 as an authoritative execution condition with respect to the held digital payload 220 and the participating entity 110.

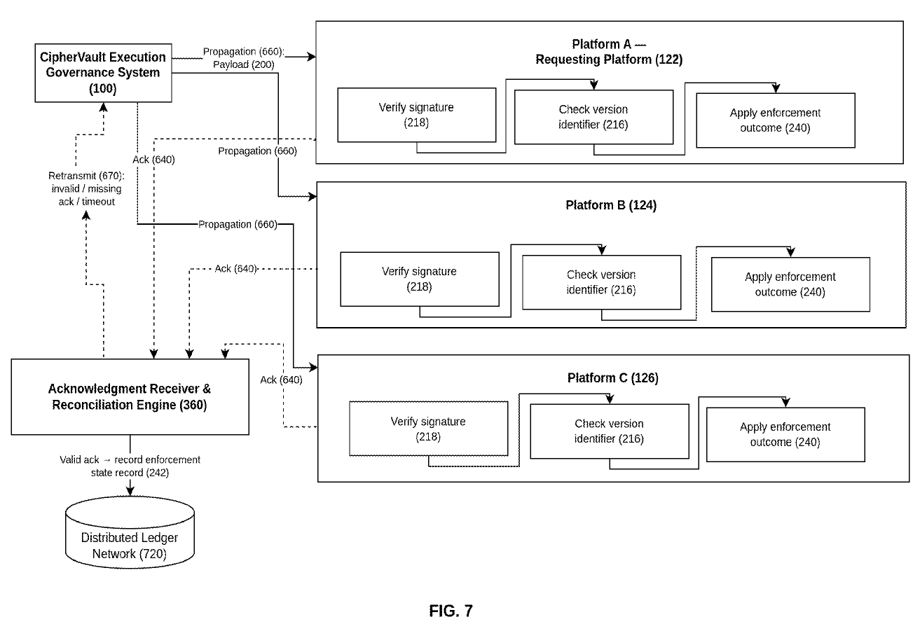

FIG. 7 illustrates a propagation, acknowledgment, and reconciliation workflow performed by the CipherVault execution governance system 100, according to aspects of the present disclosure. In some aspects, the CipherVault execution governance system 100 may transmit the execution governance payload 200, as updated to reflect the enforcement outcome 240, in parallel along three propagation 660 paths to the requesting platform 122, the settlement platform 124, and the marketplace platform 126 of the plurality of independent computing environments 120. In some aspects, the propagation 660 may comprise an outbound transmission, performed by the propagation / enforcement orchestrator 350, that delivers the execution governance payload 200 to each of the requesting platform 122, the settlement platform 124, and the marketplace platform 126 concurrently, such that each of the requesting platform 122, the settlement platform 124, and the marketplace platform 126 may apply the enforcement outcome 240 with respect to the held digital payload 220 substantially contemporaneously.

In some aspects, upon receipt of the execution governance payload 200 via the propagation 660, each of the requesting platform 122, the settlement platform 124, and the marketplace platform 126 may perform three sequential operations on the received execution governance payload 200. In some aspects, the three sequential operations may comprise, in order, (i) a cryptographic verification of the cryptographic signature 218, (ii) a check of the version identifier 216, and (iii) an application of the enforcement outcome 240.

In some aspects, the cryptographic verification of the cryptographic signature 218 may comprise cryptographically verifying, at each of the requesting platform 122, the settlement platform 124, and the marketplace platform 126, the cryptographic signature 218 applied by the cryptographic signing module 370 to the execution governance payload 200 prior to application of the enforcement outcome 240. In some aspects, upon failure of cryptographic verification of the cryptographic signature 218, the corresponding one of the requesting platform 122, the settlement platform 124, and the marketplace platform 126 may refuse to apply the enforcement outcome 240 with respect to the held digital payload 220.

In some aspects, the check of the version identifier 216 may comprise comparing the version identifier 216 carried by the received execution governance payload 200 against a latest version identifier 216 previously received for the participating entity 110 at the corresponding one of the requesting platform 122, the settlement platform 124, and the marketplace platform 126. In some aspects, the version identifier 216 may comprise a monotonically increasing version identifier propagated together with the execution governance payload 200, such that each of the requesting platform 122, the settlement platform 124, and the marketplace platform 126 may reject, as stale, any execution governance payload 200 bearing a version identifier 216 earlier than the latest version identifier 216 previously received for the participating entity 110.

In some aspects, upon successful cryptographic verification of the cryptographic signature 218 and upon a determination that the version identifier 216 is not stale, each of the requesting platform 122, the settlement platform 124, and the marketplace platform 126 may apply the enforcement outcome 240 with respect to the held digital payload 220, including by permitting, restricting, or denying release, transfer, or settlement of the held digital payload 220 in accordance with the enforcement outcome 240 carried by the execution governance payload 200.

In some aspects, each of the requesting platform 122, the settlement platform 124, and the marketplace platform 126 may return an acknowledgment signal 640 to the acknowledgment receiver & reconciliation engine 360 of the CipherVault execution governance system 100. In some aspects, the acknowledgment signal 640 returned by a corresponding one of the requesting platform 122, the settlement platform 124, and the marketplace platform 126 may confirm application of the enforcement outcome 240 at the corresponding one of the requesting platform 122, the settlement platform 124, and the marketplace platform 126. In some aspects, the acknowledgment receiver & reconciliation engine 360 may evaluate whether each acknowledgment signal 640 is valid.

In some aspects, upon a determination by the acknowledgment receiver & reconciliation engine 360 that a received acknowledgment signal 640 is valid, the acknowledgment receiver & reconciliation engine 360 may cause an enforcement state record 242 corresponding to the enforcement outcome 240 and the acknowledgment signal 640 to be recorded on the distributed ledger network 720. In some aspects, the enforcement state record 242 may be cryptographically signed by the cryptographic signing module 370 and recorded on the distributed ledger network 720 via the ledger interface 380, such that a tamper-resistant record of authorization decisions and enforcement actions taken with respect to the participating entity 110 and the held digital payload 220 may be made available to the plurality of independent computing environments 120. In some aspects, the execution governance payload 200 may comprise a cryptographically signed, machine-readable data structure that is recorded on the distributed ledger network 720 by way of the enforcement state record 242, such that the execution governance payload 200 and the corresponding enforcement outcome 240 may be subsequently retrieved and verified by any of the plurality of independent computing environments 120.

In some aspects, the CipherVault execution governance system 100 may maintain an automated audit log providing ledger-based transaction tracking for operations performed on behalf of the participating entity 110, including banking operations, escrow operations, loan issuance operations, and insurance underwriting operations. In some aspects, the automated audit log may comprise an aggregation of enforcement state records 242 recorded on the distributed ledger network 720, such that each authorization decision, each enforcement outcome 240, and each application of the execution governance payload 200 by a corresponding one of the plurality of independent computing environments 120 may be persistently logged in a tamper-resistant form.

In some aspects, upon a determination by the acknowledgment receiver & reconciliation engine 360 that a received acknowledgment signal 640 is invalid, or upon expiration of a timeout period without receipt of an acknowledgment signal 640 from a particular one of the requesting platform 122, the settlement platform 124, and the marketplace platform 126, the acknowledgment receiver & reconciliation engine 360 may initiate a reconciliation retransmit 670. In some aspects, the reconciliation retransmit 670 may comprise a reconciliation process in which the execution governance payload 200, as updated to reflect the enforcement outcome 240, is retransmitted via the propagation / enforcement orchestrator 350 along the propagation 660 to the particular one of the requesting platform 122, the settlement platform 124, and the marketplace platform 126 from which a valid acknowledgment signal 640 has not been received. In some aspects, the reconciliation retransmit 670 may be repeated until a valid acknowledgment signal 640 is received from the particular one of the requesting platform 122, the settlement platform 124, and the marketplace platform 126, such that a consistent enforcement state with respect to the participating entity 110 and the held digital payload 220 may be maintained across the plurality of independent computing environments 120 notwithstanding differences in connectivity, processing latency, or operating mode.

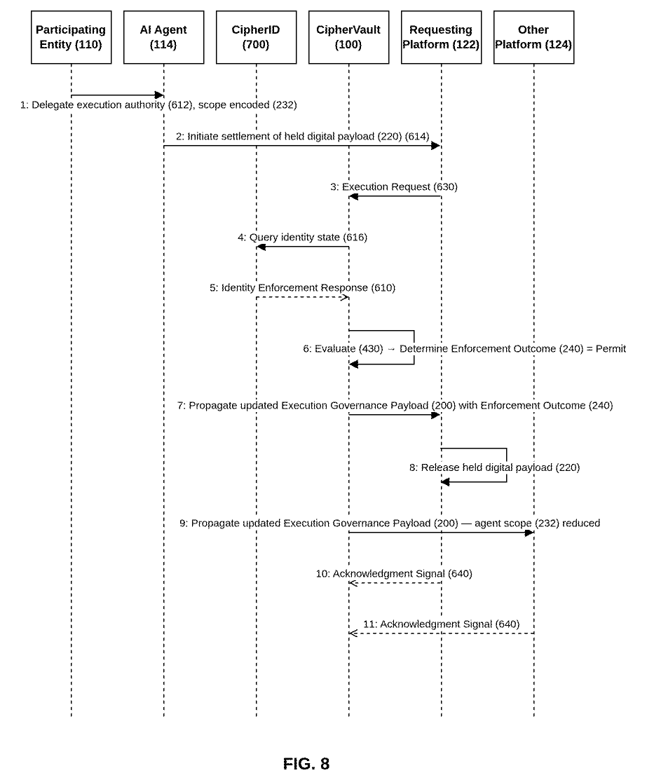

FIG. 8 illustrates a sequence diagram of an AI-agent-initiated settlement workflow governed by the CipherVault execution governance system 100, according to aspects of the present disclosure. In some aspects, the sequence diagram of FIG. 8 may depict interactions among the participating entity 110, the AI agent 114, the external identity infrastructure / CipherID 700, the CipherVault execution governance system 100, the requesting platform 122, and the settlement platform 124, in which the AI agent 114 initiates a settlement of the held digital payload 220 on behalf of the participating entity 110 and the CipherVault execution governance system 100 evaluates, permits, and propagates the resulting enforcement outcome 240.

In some aspects, in a first message of the sequence, the participating entity 110 may transmit a delegate execution authority 612 message to the AI agent 114. In some aspects, the delegate execution authority 612 message may encode an agent scope 232 within the AI agent 114, the agent scope 232 specifying operations that the AI agent 114 is authorized to initiate on behalf of the participating entity 110, classes of assets that the AI agent 114 is permitted to act upon, and limits on the AI agent 114. In some aspects, the AI agent 114 may comprise an artificial-intelligence agent bound to the participating entity 110 and configured to initiate operations on behalf of the participating entity 110, and the conditional execution constraints 212 encoded in the execution governance payload 200 may constrain an execution authority of the artificial-intelligence agent relative to the participating entity 110.

In some aspects, in a second message of the sequence, the AI agent 114 may transmit an initiate settlement 614 message to the requesting platform 122 to initiate settlement of the held digital payload 220 maintained in the conditional holding state 520 at the requesting platform 122. In some aspects, in a third message of the sequence, the requesting platform 122 may submit an execution request 630 to the CipherVault execution governance system 100, the execution request 630 comprising a request to perform at least one of a transfer, a settlement, a release, an asset movement, a delegated action, or an operation initiated by the artificial-intelligence agent bound to the participating entity 110, with respect to the held digital payload 220.

In some aspects, in a fourth message of the sequence, the CipherVault execution governance system 100 may transmit a query identity state 616 message to the external identity infrastructure / CipherID 700 to query an identity state of the participating entity 110 in connection with the execution request 630. In some aspects, in a fifth message of the sequence, the external identity infrastructure / CipherID 700 may return an identity enforcement response 610 to the CipherVault execution governance system 100, the identity enforcement response 610 conveying an authorization state and associated enforcement directives applicable to the participating entity 110 in respect of the execution request 630.

In some aspects, in a sixth message of the sequence, the CipherVault execution governance system 100 may perform a self-message corresponding to the step 430, in which the evaluator / outcome determinator 340 evaluates the execution request 630 against the execution governance payload 200 in light of the identity enforcement response 610 and determines an enforcement outcome 240 equal to a permit outcome 240a. In some aspects, the step 430 performed as the self-message may proceed through the chain of constraint-check decisions described with reference to FIG. 6, including evaluation of the authorization state field 210, the delegated permission 212a, the jurisdictional restriction 212b, the compliance condition 212c, and the behavioral restriction 212d encoded in the execution governance payload 200, such that the enforcement outcome 240 reflects compliance of the execution request 630 with the authorization state field 210, the conditional execution constraints 212, and the enforcement directives 214.

In some aspects, in a seventh message of the sequence, the CipherVault execution governance system 100 may transmit to the requesting platform 122 the execution governance payload 200, as updated to reflect the enforcement outcome 240 equal to the permit outcome 240a, such that the requesting platform 122 may apply the permit outcome 240a with respect to the held digital payload 220. In some aspects, in an eighth message of the sequence, the requesting platform 122 may perform a self-message corresponding to release of the held digital payload 220 from the conditional holding state 520, in accordance with the permit outcome 240a carried by the updated execution governance payload 200.

In some aspects, in a ninth message of the sequence, the CipherVault execution governance system 100 may transmit to the settlement platform 124 the updated execution governance payload 200 with the agent scope 232 reduced. In some aspects, operations of the AI agent 114 may be revocable by updating the execution governance payload 200 to remove or modify the agent scope 232 encoded therein, and propagating the updated execution governance payload 200 to the plurality of independent computing environments 120, such that subsequent operations attempted by the AI agent 114 are evaluated against the reduced agent scope 232. In some aspects, the reduction of the agent scope 232 propagated to the settlement platform 124 may reflect that an execution authority delegated to the AI agent 114 in respect of the held digital payload 220 has been consumed by the permit outcome 240a applied at the requesting platform 122.

In some aspects, the AI agent 114 may be bound to the participating entity 110 by a parent-identity reference 230 encoded in the execution governance payload 200, and a scope of the execution authority of the AI agent 114 may be encoded in the execution governance payload 200 as the agent scope 232. In some aspects, the parent-identity reference 230 may identify the user / business 112 on whose behalf the AI agent 114 acts, such that the execution request 630 initiated by the AI agent 114 is evaluated against the authorization state field 210, the conditional execution constraints 212, and the enforcement directives 214 associated with the user / business 112. In some aspects, operations of the AI agent 114 may be revocable by updating the execution governance payload 200 to remove or modify the agent scope 232 and propagating the updated execution governance payload 200 to the plurality of independent computing environments 120, such that revocation or modification of the execution authority of the AI agent 114 is reflected consistently across the requesting platform 122, the settlement platform 124, and additional platforms of the plurality of independent computing environments 120.

In some aspects, in a tenth message of the sequence, the requesting platform 122 may return an acknowledgment signal 640 to the CipherVault execution governance system 100 to confirm application of the enforcement outcome 240 with respect to the held digital payload 220 at the requesting platform 122. In some aspects, in an eleventh message of the sequence, the settlement platform 124 may return an acknowledgment signal 640 to the CipherVault execution governance system 100 to confirm application of the updated execution governance payload 200 carrying the reduced agent scope 232 at the settlement platform 124. In some aspects, each acknowledgment signal 640 returned by the requesting platform 122 and the settlement platform 124 may be received and evaluated by the acknowledgment receiver & reconciliation engine 360 in the manner described with reference to FIG. 7, including triggering of a reconciliation process upon absence of a valid acknowledgment signal 640 within a timeout period.

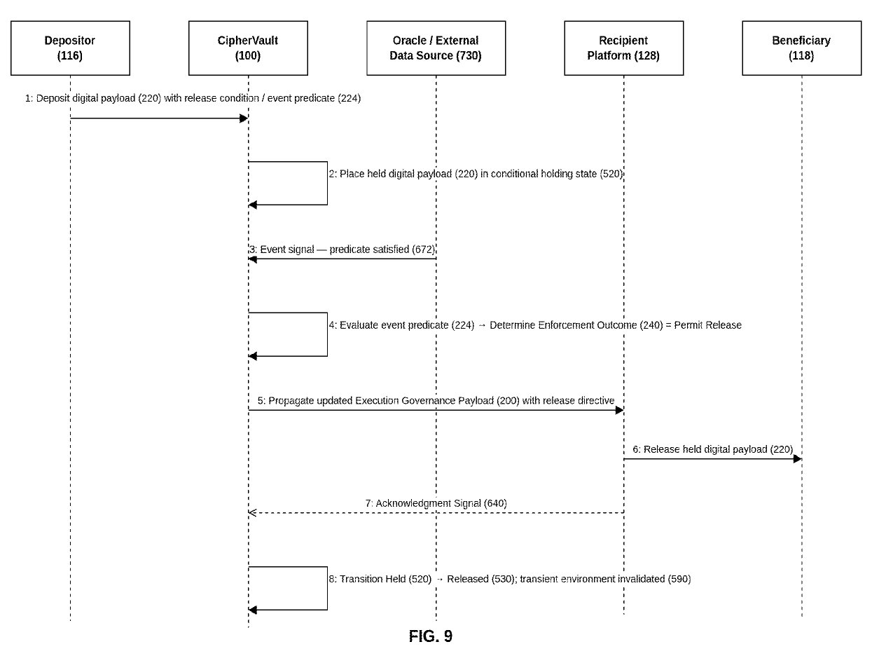

FIG. 9 illustrates a sequence diagram of a conditional release workflow for the held digital payload 220 governed by the CipherVault execution governance system 100 in response to an event predicate satisfied by an external oracle, according to aspects of the present disclosure. In some aspects, the sequence diagram of FIG. 9 may depict interactions among a depositor 116, the CipherVault execution governance system 100, an oracle / external data source 730, the regulated exchange platform 128 acting as a recipient platform, and a beneficiary 118, in which the held digital payload 220 is deposited subject to a release condition embodied as an event predicate 224, and the held digital payload 220 is released to the beneficiary 118 upon satisfaction of the event predicate 224.

In some aspects, in a first message of the sequence, the depositor 116 may transmit, to the CipherVault execution governance system 100, the held digital payload 220 together with the release condition embodied as the event predicate 224. In some aspects, the depositor 116 may comprise the participating entity 110, or another participating entity acting on behalf of the beneficiary 118, that deposits the held digital payload 220 for conditional release. In some aspects, the event predicate 224 may comprise a machine-evaluable condition encoded within the execution governance payload 200, satisfaction of which causes release of the held digital payload 220 to a designated recipient.

In some aspects, the release condition may comprise an event predicate 224 that is evaluable against at least one of an external data source, an oracle input, a counterparty confirmation signal, or a time-based trigger. In some aspects, the external data source may comprise an off-chain data feed reporting a state of an external system, the oracle input may comprise a signal supplied by the oracle / external data source 730 that attests to an off-chain fact, the counterparty confirmation signal may comprise a confirmation message returned by a counterparty to a transaction involving the held digital payload 220, and the time-based trigger may comprise elapse of a temporal interval or arrival of a specified time. In some aspects, release of the held digital payload 220 to the designated recipient may be conditioned on satisfaction of the event predicate 224, such that release, transfer, or settlement of the held digital payload 220 is deferred until the event predicate 224 is evaluated as satisfied.

In some aspects, in a second message of the sequence, the CipherVault execution governance system 100 may perform a self-message in which the held digital payload 220 is placed in the conditional holding state 520. In some aspects, while the held digital payload 220 resides in the conditional holding state 520, the authorization state field 210, the conditional execution constraints 212, and the enforcement directives 214 encoded in the execution governance payload 200 may continue to bind the plurality of independent computing environments 120 with respect to the held digital payload 220, pending evaluation of the event predicate 224.

In some aspects, in a third message of the sequence, the oracle / external data source 730 may transmit, to the CipherVault execution governance system 100, an event signal 672 indicating that the event predicate 224 has been satisfied. In some aspects, the event signal 672 may comprise a machine-readable signal originating from the oracle / external data source 730 that conveys a state of an external data source, an oracle input, a counterparty confirmation signal, or a time-based trigger against which the event predicate 224 is evaluated.

In some aspects, in a fourth message of the sequence, the CipherVault execution governance system 100 may perform a self-message in which the evaluator / outcome determinator 340 evaluates the event predicate 224 in light of the event signal 672 and determines an enforcement outcome 240 equal to a permit release outcome. In some aspects, evaluation of the event predicate 224 may comprise determining that a state reported by the event signal 672 satisfies the release condition encoded in the execution governance payload 200, such that release, transfer, or settlement of the held digital payload 220 is to be permitted. In some aspects, the enforcement outcome 240 determined as the permit release outcome may be populated within the execution governance payload 200, and the version identifier 216 may be incremented to distinguish the updated execution governance payload 200 from prior instances.

In some aspects, in a fifth message of the sequence, the CipherVault execution governance system 100 may transmit, to the regulated exchange platform 128 acting as the recipient platform, the execution governance payload 200, as updated to reflect the enforcement outcome 240, carrying a release directive that authorizes release of the held digital payload 220 to the beneficiary 118. In some aspects, the release directive carried by the updated execution governance payload 200 may bind the regulated exchange platform 128 to release the held digital payload 220 in accordance with the enforcement outcome 240 and the event predicate 224.

In some aspects, in a sixth message of the sequence, the regulated exchange platform 128 may release the held digital payload 220 to the beneficiary 118 in accordance with the release directive carried by the updated execution governance payload 200. In some aspects, the beneficiary 118 may comprise the designated recipient identified by the execution governance payload 200 to whom the held digital payload 220 is released upon satisfaction of the event predicate 224.

In some aspects, in a seventh message of the sequence, the regulated exchange platform 128 may return an acknowledgment signal 640 to the CipherVault execution governance system 100 to confirm application of the enforcement outcome 240 and release of the held digital payload 220 at the regulated exchange platform 128. In some aspects, the acknowledgment signal 640 returned by the regulated exchange platform 128 may be received and evaluated by the acknowledgment receiver & reconciliation engine 360 in the manner described with reference to FIG. 7, including triggering of a reconciliation process upon absence of a valid acknowledgment signal 640 within a timeout period.

In some aspects, in an eighth message of the sequence, the CipherVault execution governance system 100 may perform a self-message in which the held digital payload 220 transitions from the conditional holding state 520 to a released 530 state and the transient execution environment associated with the held digital payload 220 is invalidated as a transient environment invalidated 590 state. In some aspects, invalidation of the transient execution environment as the transient environment invalidated 590 state may comprise a zero-residue cleansing of the transient execution environment associated with the held digital payload 220, in which ephemeral state, intermediate computation artifacts, and cached credentials associated with the conditional release workflow are cleared from the transient execution environment.

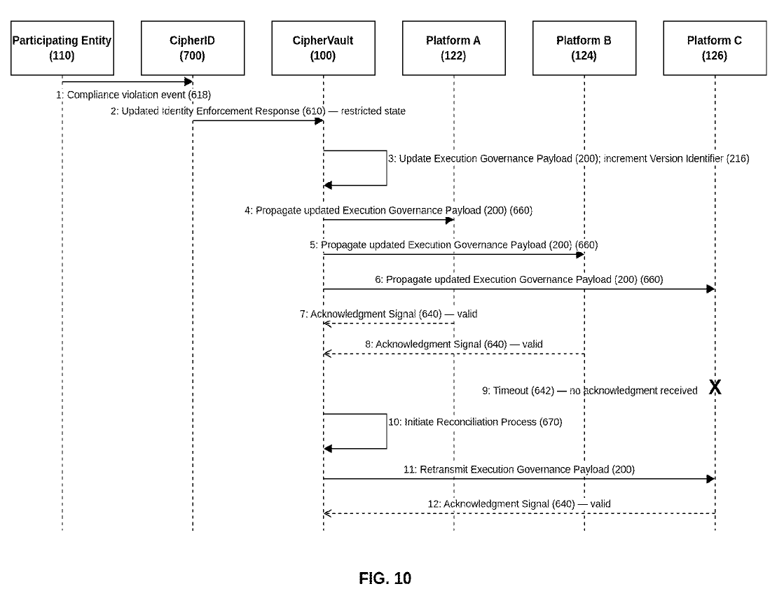

FIG. 10 illustrates a sequence diagram of an enforcement state change propagation and reconciliation workflow governed by the CipherVault execution governance system 100, according to aspects of the present disclosure. In some aspects, the sequence diagram of FIG. 10 may depict interactions among the participating entity 110, the external identity infrastructure / CipherID 700, the CipherVault execution governance system 100, the requesting platform 122 acting as a Platform A, the settlement platform 124 acting as a Platform B, and the marketplace platform 126 acting as a Platform C, in which a change in identity-related enforcement state associated with the participating entity 110 is propagated by the CipherVault execution governance system 100 to the plurality of independent computing environments 120 and reconciled in the presence of a missing acknowledgment.

In some aspects, in a first message of the sequence, the participating entity 110 may transmit, to the external identity infrastructure / CipherID 700, a compliance violation event 618. In some aspects, the compliance violation event 618 may comprise a machine-readable signal indicating that conduct attributable to, or a condition associated with, the participating entity 110 has triggered a regulatory, policy, or jurisdictional condition observed by the external identity infrastructure / CipherID 700, such as a know-your-customer condition, an anti-money-laundering condition, a sanctions condition, or another compliance condition applicable to the participating entity 110.

In some aspects, in a second message of the sequence, the external identity infrastructure / CipherID 700 may transmit, to the CipherVault execution governance system 100, an updated identity enforcement response 610 indicating a restricted state for the participating entity 110. In some aspects, the updated identity enforcement response 610 may convey a revised authorization state and associated enforcement directives applicable to the participating entity 110 in light of the compliance violation event 618, such that the authorization state field 210 carried by the execution governance payload 200 may be derived at least in part from the updated identity enforcement response 610.

In some aspects, in a third message of the sequence, the CipherVault execution governance system 100 may perform a self-message in which the execution governance payload 200 associated with the participating entity 110 is updated to reflect the restricted state conveyed by the updated identity enforcement response 610, and the version identifier 216 carried by the execution governance payload 200 is incremented. In some aspects, updating the execution governance payload 200 may comprise revising the authorization state field 210, the conditional execution constraints 212, and the enforcement directives 214 as appropriate to the restricted state, and applying the cryptographic signature 218 to the updated execution governance payload 200 by the cryptographic signing module 370 prior to outbound transmission.

In some aspects, in a fourth message, a fifth message, and a sixth message of the sequence, the CipherVault execution governance system 100 may transmit, in parallel along the propagation 660, the updated execution governance payload 200 to the requesting platform 122, the settlement platform 124, and the marketplace platform 126, respectively. In some aspects, propagation of the updated execution governance payload 200 along the propagation 660 may be performed by the propagation / enforcement orchestrator 350, such that the requesting platform 122, the settlement platform 124, and the marketplace platform 126 may apply the restricted authorization state with respect to pending and subsequent execution requests on behalf of the participating entity 110 substantially contemporaneously.

In some aspects, in a seventh message of the sequence, the requesting platform 122 may return a valid acknowledgment signal 640 to the CipherVault execution governance system 100 to confirm application of the updated execution governance payload 200 at the requesting platform 122. In some aspects, in an eighth message of the sequence, the settlement platform 124 may return a valid acknowledgment signal 640 to the CipherVault execution governance system 100 to confirm application of the updated execution governance payload 200 at the settlement platform 124. In some aspects, each valid acknowledgment signal 640 returned by the requesting platform 122 and the settlement platform 124 may be received and evaluated by the acknowledgment receiver & reconciliation engine 360 in the manner described with reference to FIG. 7.

In some aspects, a ninth interaction of the sequence may comprise a timeout 642 marker on a lifeline of the marketplace platform 126, indicating that no acknowledgment signal 640 has been received from the marketplace platform 126 within a timeout period associated with the propagation 660. In some aspects, the timeout 642 may correspond to expiration of a timeout period maintained by the acknowledgment receiver & reconciliation engine 360, during which a valid acknowledgment signal 640 is expected to be received from each of the plurality of independent computing environments 120 to which the updated execution governance payload 200 has been propagated along the propagation 660.

In some aspects, in a tenth message of the sequence, the CipherVault execution governance system 100 may perform a self-message in which the acknowledgment receiver & reconciliation engine 360 initiates a reconciliation retransmit 670 with respect to the marketplace platform 126. In some aspects, initiation of the reconciliation retransmit 670 may be triggered by the timeout 642 on the lifeline of the marketplace platform 126, and may direct the propagation / enforcement orchestrator 350 to retransmit the updated execution governance payload 200 to the marketplace platform 126.

In some aspects, in an eleventh message of the sequence, the CipherVault execution governance system 100 may retransmit the updated execution governance payload 200 to the marketplace platform 126 along the propagation 660 as part of the reconciliation retransmit 670. In some aspects, the retransmitted execution governance payload 200 may carry the same incremented version identifier 216 and the same cryptographic signature 218 as the prior transmission, such that the marketplace platform 126 may cryptographically verify the cryptographic signature 218 and check the version identifier 216 in the manner described with reference to FIG. 7 prior to application of the updated execution governance payload 200.

In some aspects, in a twelfth message of the sequence, the marketplace platform 126 may return a valid acknowledgment signal 640 to the CipherVault execution governance system 100 to confirm application of the updated execution governance payload 200 at the marketplace platform 126. In some aspects, upon receipt of the valid acknowledgment signal 640 from the marketplace platform 126, the acknowledgment receiver & reconciliation engine 360 may conclude the reconciliation retransmit 670, such that a consistent enforcement state reflecting the restricted authorization state of the participating entity 110 may be maintained across the requesting platform 122, the settlement platform 124, and the marketplace platform 126 notwithstanding the prior absence of an acknowledgment signal 640 from the marketplace platform 126 within the timeout period.

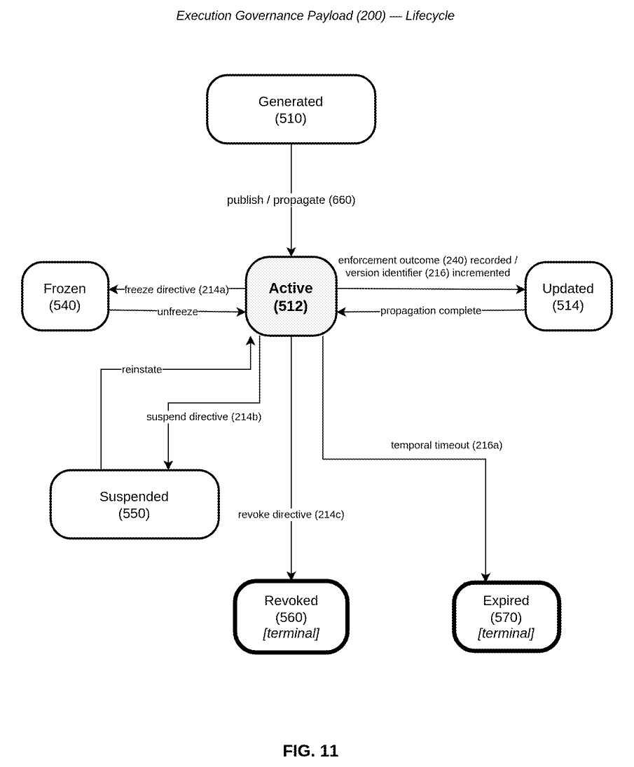

FIG. 11 illustrates a state machine diagram depicting a lifecycle of the execution governance payload 200, according to aspects of the present disclosure. In some aspects, the lifecycle of the execution governance payload 200 may comprise a generated 510 state, an active 512 state, an updated 514 state, the frozen 540 state, the suspended 550 state, the revoked 560 state, and the expired 570 state, with transitions among the states being driven by the enforcement directives 214, the version identifier 216, and the propagation 660 performed by the propagation / enforcement orchestrator 350.

In some aspects, the generated 510 state may comprise an entry state of the lifecycle in which the execution governance payload 200 is assembled by the payload generator 310 and cryptographically signed by the cryptographic signing module 370. In some aspects, the execution governance payload 200 in the generated 510 state may encapsulate the authorization state field 210, the conditional execution constraints 212, and the enforcement directives 214 associated with the participating entity 110, together with the version identifier 216 and the cryptographic signature 218, prior to outbound transmission to the plurality of independent computing environments 120.

In some aspects, the execution governance payload 200 may transition from the generated 510 state to an active 512 state upon publication and propagation 660 of the execution governance payload 200 to the plurality of independent computing environments 120. In some aspects, the active 512 state may comprise a primary operational state of the lifecycle in which the execution governance payload 200 is in force across the plurality of independent computing environments 120 and binds each of the plurality of independent computing environments 120 to apply the authorization state field 210, the conditional execution constraints 212, and the enforcement directives 214 with respect to the participating entity 110. In some aspects, transitions from the active 512 state to other states of the lifecycle may originate from the active 512 state and may return to the active 512 state where applicable.

In some aspects, the execution governance payload 200 may transition from the active 512 state to an updated 514 state upon recording of an enforcement outcome 240 within the execution governance payload 200 and incrementing of the version identifier 216 by the CipherVault execution governance system 100. In some aspects, the updated 514 state may comprise a transient state of the lifecycle in which the execution governance payload 200, as updated to reflect the enforcement outcome 240 and to carry the incremented version identifier 216, is cryptographically signed by the cryptographic signing module 370 and transmitted along the propagation 660 to the plurality of independent computing environments 120. In some aspects, the execution governance payload 200 may return from the updated 514 state to the active 512 state upon completion of the propagation 660, such that the updated execution governance payload 200 resumes operation as the authoritative execution condition across the plurality of independent computing environments 120.

In some aspects, the execution governance payload 200 may transition from the active 512 state to the frozen 540 state in response to a freeze directive 214a carried by the enforcement directives 214. In some aspects, while the execution governance payload 200 resides in the frozen 540 state, release, transfer, or settlement of the held digital payload 220 may be paused at each of the plurality of independent computing environments 120, and execution requests evaluated against the execution governance payload 200 may be restricted or denied for the duration of the freeze directive 214a. In some aspects, the execution governance payload 200 may return from the frozen 540 state to the active 512 state upon an unfreeze event, in which the freeze directive 214a is cleared by the enforcement directive engine 330 and an updated execution governance payload 200 reflecting the clearance is propagated to the plurality of independent computing environments 120.

In some aspects, the execution governance payload 200 may transition from the active 512 state to the suspended 550 state in response to a suspend directive 214b carried by the enforcement directives 214. In some aspects, while the execution governance payload 200 resides in the suspended 550 state, operations governed by the execution governance payload 200 may be deferred at each of the plurality of independent computing environments 120 for the duration of the suspend directive 214b. In some aspects, the execution governance payload 200 may return from the suspended 550 state to the active 512 state upon a reinstate event, in which the suspend directive 214b is cleared by the enforcement directive engine 330 and an updated execution governance payload 200 reflecting the reinstatement is propagated to the plurality of independent computing environments 120.

In some aspects, the execution governance payload 200 may transition from the active 512 state to the revoked 560 state in response to a revoke directive 214c carried by the enforcement directives 214. In some aspects, the revoked 560 state may comprise a terminal state of the lifecycle of the execution governance payload 200, in which authority of the execution governance payload 200 to govern release, transfer, or settlement of the held digital payload 220 is withdrawn from the plurality of independent computing environments 120 and no further transitions from the revoked 560 state to the active 512 state may occur.

In some aspects, the execution governance payload 200 may transition from the active 512 state to the expired 570 state upon elapse of a temporal timeout 216a associated with the execution governance payload 200. In some aspects, the expired 570 state may comprise a further terminal state of the lifecycle of the execution governance payload 200, in which the execution governance payload 200 ceases to operate as the authoritative execution condition across the plurality of independent computing environments 120 upon automatic expiration without further evaluation of an execution request 630. In some aspects, upon entry into the expired 570 state, a successor execution governance payload 200 associated with the participating entity 110 may be generated by the payload generator 310 and may re-enter the lifecycle at the generated 510 state.

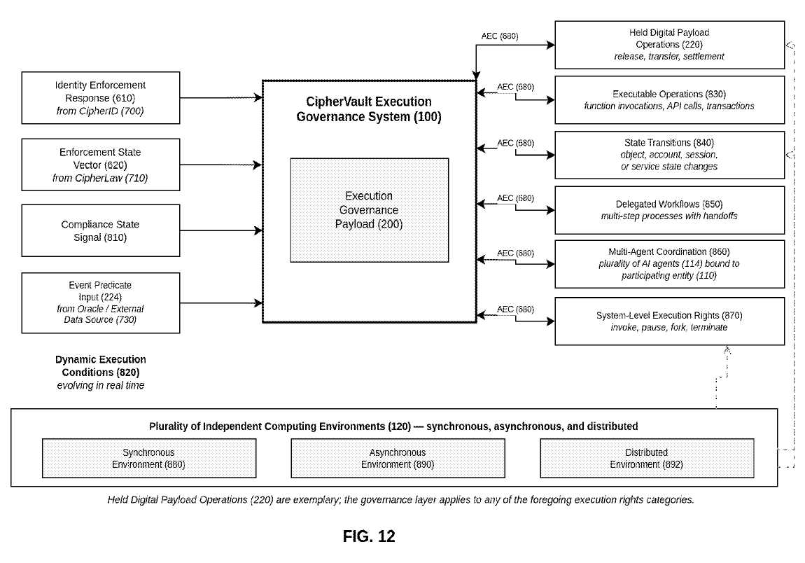

FIG. 12 illustrates a conceptual architecture diagram showing a governance layer provided by the CipherVault execution governance system 100 applied to a broad genus of execution rights across interoperable environments, according to aspects of the present disclosure. In some aspects, the CipherVault execution governance system 100 may operate as a central governance layer that encapsulates the execution governance payload 200 and that mediates between a set of dynamic inputs supplied to the CipherVault execution governance system 100 and a plurality of governed execution rights categories that may execute within the plurality of independent computing environments 120.

In some aspects, the CipherVault execution governance system 100 may receive a plurality of dynamic inputs that collectively form a dynamic execution conditions 820 evolving in real time, against which the execution governance payload 200 may be evaluated. In some aspects, the dynamic execution conditions 820 may comprise (i) the identity enforcement response 610 supplied by the external identity infrastructure / CipherID 700, (ii) the enforcement state vector 620 supplied by the external legal execution infrastructure / CipherLaw 710, (iii) a compliance state signal 810, and (iv) an event predicate 224 supplied by the oracle / external data source 730. In some aspects, the compliance state signal 810 may comprise a machine-readable signal that conveys a regulatory, policy, or jurisdictional compliance state applicable to the participating entity 110 or to operations initiated by or on behalf of the participating entity 110, and that may be evaluated by the evaluator / outcome determinator 340 in conjunction with the identity enforcement response 610 and the enforcement state vector 620. In some aspects, the event predicate 224 supplied by the oracle / external data source 730 may comprise a machine-evaluable condition against which an event signal originating from the oracle / external data source 730 is evaluated, as described with reference to the conditional release workflow above. In some aspects, the identity enforcement response 610, the enforcement state vector 620, the compliance state signal 810, and the event predicate 224 may evolve over time, such that the dynamic execution conditions 820 collectively reflect a current state of identity, legal, compliance, and event-based conditions applicable to the participating entity 110.

In some aspects, the CipherVault execution governance system 100 may apply the execution governance payload 200 as an authoritative execution condition 680 governing each of a plurality of governed execution rights categories. In some aspects, the authoritative execution condition 680 may comprise a bidirectional binding between the CipherVault execution governance system 100 and each of the governed execution rights categories, in which the CipherVault execution governance system 100 supplies the execution governance payload 200 to the governed execution rights category as an authoritative execution condition, and in which the governed execution rights category returns enforcement state information to the CipherVault execution governance system 100 reflecting application of the execution governance payload 200.

In some aspects, the governed execution rights categories may comprise (i) operations on the held digital payload 220, including release, transfer, and settlement operations as described above, (ii) an executable operations 830, (iii) a state transitions 840, (iv) a delegated workflows 850, (v) a multi-agent coordination 860, and (vi) a system-level execution rights 870. In some aspects, the executable operations 830 may comprise function invocations, application programming interface calls, and transactions performed by or on behalf of the participating entity 110 across the plurality of independent computing environments 120. In some aspects, the state transitions 840 may comprise object state changes, account state changes, session state changes, or service state changes that are governed by the execution governance payload 200. In some aspects, the delegated workflows 850 may comprise multi-step processes that include handoffs between actors or platforms, in which an output of one step is consumed as an input to a subsequent step, and in which each step of the multi-step process is bound by the authoritative execution condition 680. In some aspects, the multi-agent coordination 860 may comprise coordination of a plurality of AI agents 114 bound to the participating entity 110, in which a scope of execution authority of each of the plurality of AI agents 114 is encoded in the execution governance payload 200 and is enforceable across the plurality of independent computing environments 120. In some aspects, the system-level execution rights 870 may comprise invoke rights, pause rights, fork rights, and terminate rights with respect to processes, services, or workflows governed by the execution governance payload 200. In some aspects, operations on the held digital payload 220 may comprise an exemplary category of the governed execution rights categories, and the governance layer provided by the CipherVault execution governance system 100 may apply to any of the foregoing governed execution rights categories.

In some aspects, the governed execution rights categories may execute within the plurality of independent computing environments 120, which may comprise a synchronous environment 880, an asynchronous environment 890, and a distributed environment 892. In some aspects, the synchronous environment 880 may comprise an environment in which a request and a corresponding response are exchanged in a tightly coupled interaction with low latency between request submission and response receipt. In some aspects, the asynchronous environment 890 may comprise an environment in which operations are queued, deferred, or processed out of order, such that submission of an operation and observation of a corresponding result occur at different times. In some aspects, the distributed environment 892 may comprise an environment in which operations are executed across a plurality of nodes that may individually observe partial state, and in which coordination among the plurality of nodes may be performed to converge upon a consistent enforcement state. In some aspects, any of the governed execution rights categories may execute within any of the synchronous environment 880, the asynchronous environment 890, and the distributed environment 892, such that the governance layer provided by the CipherVault execution governance system 100 may apply across heterogeneous environment types.

In some aspects, the CipherVault execution governance system 100 may expose, via the API gateway 390, an application programming interface configured to permit a third-party platform of the plurality of independent computing environments 120 to submit execution requests to the CipherVault execution governance system 100 and to receive, in return, resulting enforcement outcomes specifying that release, transfer, or settlement of the held digital payload 220 is permitted, restricted, or denied. In some aspects, the application programming interface exposed by the API gateway 390 may comprise an inbound endpoint through which the third-party platform submits an execution request 630 with respect to the held digital payload 220 or with respect to one or more of the executable operations 830, the state transitions 840, the delegated workflows 850, the multi-agent coordination 860, or the system-level execution rights 870, and an outbound endpoint through which the CipherVault execution governance system 100 returns the execution governance payload 200, as updated to reflect the enforcement outcome 240, together with the enforcement outcome 240 specifying whether release, transfer, or settlement of the held digital payload 220 is permitted, restricted, or denied. In some aspects, exposure of the application programming interface via the API gateway 390 may permit third-party platforms across the synchronous environment 880, the asynchronous environment 890, and the distributed environment 892 to interoperate with the CipherVault execution governance system 100 as the authoritative governance layer for the governed execution rights categories.

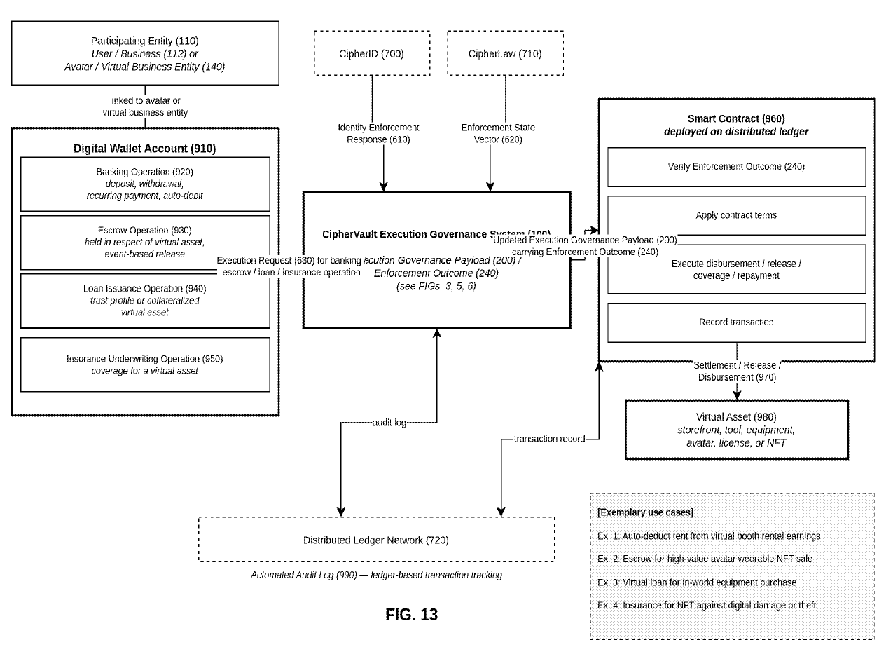

FIG. 13 illustrates a commercial metaverse banking embodiment of the CipherVault execution governance system 100 as applied to a digital wallet account 910 associated with an avatar or a virtual business entity, according to aspects of the present disclosure. In some aspects, the embodiment of FIG. 13 may depict interactions among the participating entity 110, the digital wallet account 910, the CipherVault execution governance system 100, the external identity infrastructure / CipherID 700, the external legal execution infrastructure / CipherLaw 710, a smart contract 960, a virtual asset 980, and the distributed ledger network 720, in which banking, escrow, loan issuance, and insurance underwriting operations initiated from within an immersive platform are evaluated by the CipherVault execution governance system 100 and enforced through execution of the smart contract 960 deployed on the distributed ledger network 720.

In some aspects, the participating entity 110 may comprise the user / business 112 or an avatar / virtual business entity 140 associated with the user / business 112. In some aspects, the avatar / virtual business entity 140 may comprise an avatar identity that represents a human user within an immersive platform, a virtual business entity that conducts commercial activity within an immersive platform, or a combination thereof. In some aspects, the participating entity 110 may be linked to the digital wallet account 910, such that operations initiated by or on behalf of the avatar / virtual business entity 140 are bound to the authorization state, the conditional execution constraints 212, and the enforcement directives 214 encoded in the execution governance payload 200 associated with the participating entity 110.

In some aspects, the digital wallet account 910 may comprise a persistent wallet linked to either an avatar identity or a business entity identity, and may maintain continuity of the authorization state, the conditional execution constraints 212, and the enforcement directives 214 across sessions of the participating entity 110 and across the plurality of independent computing environments 120. In some aspects, the digital wallet account 910 may persist between disconnection and reconnection of the avatar / virtual business entity 140 to an immersive platform, and may carry the parent-identity reference 230 such that the digital wallet account 910 remains bound to the user / business 112 on whose behalf the avatar / virtual business entity 140 acts. In some aspects, the CipherVault execution governance system 100 may support onboarding of both individual avatar participating entities 110 and virtual business entity participating entities 110 through a unified account creation flow, such that an avatar identity and a virtual business entity identity may each be associated with a corresponding digital wallet account 910 by way of a common onboarding procedure.

In some aspects, the digital wallet account 910 may enclose a plurality of operation sub-rows that define classes of operations supported against the digital wallet account 910. In some aspects, the operation sub-rows may comprise a banking operation 920, an escrow operation 930, a loan issuance operation 940, and an insurance underwriting operation 950.

In some aspects, the banking operation 920 may comprise one or more of a deposit, a withdrawal, a recurring payment, or an auto-debit performed against the digital wallet account 910. In some aspects, the deposit and the withdrawal may comprise inflows and outflows, respectively, of digital funds to and from the digital wallet account 910 across the plurality of independent computing environments 120, such that the participating entity 110 may credit and debit the digital wallet account 910 from immersive platforms communicatively coupled to the CipherVault execution governance system 100. In some aspects, the recurring payment and the auto-debit may comprise scheduled or event-triggered debits of the digital wallet account 910 that are performed on a periodic basis or upon occurrence of a specified condition, such as auto-deduction of rent from booth rental earnings of an avatar participating entity 110 operating a virtual booth within an immersive platform.

In some aspects, the insurance underwriting operation 950 may be implemented by way of an underwriting engine of the CipherVault execution governance system 100, or invoked by the CipherVault execution governance system 100, that determines coverage terms for the virtual asset 980 in respect of which coverage is sought. In some aspects, the coverage terms determined by the underwriting engine may comprise one or more of a coverage amount, a premium amount, a deductible, a coverage period, an enumerated set of covered perils, and one or more exclusions. In some aspects, the enumerated set of covered perils may, for example, comprise one or more of digital damage to the virtual asset 980, theft of the virtual asset 980, account compromise of the digital wallet account 910, smart-contract exploit affecting the virtual asset 980, unauthorized transfer of the virtual asset 980, or loss of access credentials associated with the participating entity 110. In some aspects, the underwriting engine may evaluate one or more underwriting criteria in determining the coverage terms, which may include one or more of a declared or oracle-attested valuation of the virtual asset 980, such as an NFT floor price or a recent sale price reported by a marketplace platform 126 or a regulated exchange platform 128; a provenance record of the virtual asset 980 retrieved from the distributed ledger network 720; a rarity or scarcity metric associated with the virtual asset 980; a transaction history of the participating entity 110; a metaverse-derived trust profile of the participating entity 110, including in a manner analogous to the metaverse-derived trust profile evaluated by the loan approval engine described above with reference to the loan issuance operation 940; a historical loss or claim record associated with the participating entity 110 or with an asset class to which the virtual asset 980 belongs; the identity enforcement response 610 supplied by the external identity infrastructure / CipherID 700; the enforcement state vector 620 supplied by the external legal execution infrastructure / CipherLaw 710; and a jurisdictional restriction 212b applicable to the participating entity 110 or to the virtual asset 980.

In some aspects, the underwriting engine may consume one or more data feeds in evaluating the underwriting criteria and in determining the coverage terms. In some aspects, the data feeds may comprise one or more of an oracle / external data source 730 supplying market price data, on-chain provenance data, or loss event data with respect to the virtual asset 980; the compliance state signal 810; the event predicate 224; one or more counterparty confirmation signals; and telemetry supplied by the marketplace platform 126. In some aspects, the coverage terms and a premium schedule determined by the underwriting engine may be encoded within a smart contract 960 deployed on the distributed ledger network 720, such that the smart contract 960 enforces the coverage terms and the premium schedule with respect to the participating entity 110 and the virtual asset 980. In some aspects, the smart contract 960 may automatically debit a recurring premium from the digital wallet account 910 of the participating entity 110, in a manner analogous to the recurring payment and auto-debit aspects of the banking operation 920 described above, with each automatic debit being evaluated by the CipherVault execution governance system 100 against the execution governance payload 200 prior to execution by the smart contract 960. In some aspects, upon occurrence of a covered peril attested by an event signal 672 supplied by the oracle / external data source 730 that satisfies an event predicate 224 encoded within the execution governance payload 200 or the smart contract 960, the smart contract 960 may execute a settlement / release / disbursement 970 of a coverage payout to the digital wallet account 910 of the participating entity 110 in accordance with the encoded coverage terms.

In some aspects, the insurance underwriting operation 950 may further comprise a claims workflow in which a claim execution request 630 is submitted via the requesting platform 122 on behalf of the participating entity 110. In some aspects, the claim execution request 630 may be evaluated by the evaluator / outcome determinator 340 against the execution governance payload 200 and against an event predicate 224 corresponding to the asserted covered peril, including, for example, an oracle-attested theft event or an oracle-attested digital damage event reported by the oracle / external data source 730. In some aspects, evaluation of the claim execution request 630 may produce an enforcement outcome 240 specifying that the coverage payout is to be permitted, restricted, or denied, and the enforcement outcome 240 may be applied by the smart contract 960 in executing or withholding the settlement / release / disbursement 970 of the coverage payout. In some aspects, the claim outcome may be recorded as an enforcement state record 242 on the distributed ledger network 720 via the automated audit log 990, such that a tamper-resistant record of claim adjudications performed in respect of the insurance underwriting operation 950 may be made available to the plurality of independent computing environments 120. In some aspects, the underwriting engine may further support dynamic re-underwriting, in which the coverage terms may be adjusted upon a change in the dynamic execution conditions 820, including, for example, a change in the identity enforcement response 610, a change in the enforcement state vector 620, a change in the compliance state signal 810, or a change in a valuation of the virtual asset 980 reported by the oracle / external data source 730. In some aspects, the adjustment of the coverage terms in dynamic re-underwriting may comprise one or more of re-pricing the premium, modifying a scope of covered perils, modifying the deductible, or modifying the coverage period, and the updated coverage terms may be propagated to the plurality of independent computing environments 120 by way of an updated execution governance payload 200 carrying an incremented version identifier 216 and a refreshed cryptographic signature 218.

In some aspects, the escrow operation 930 may comprise an operation in which a held digital payload 220 is held in respect of a virtual asset 980 and is released upon satisfaction of an event-based release condition, in the manner described above with reference to the conditional release workflow. In some aspects, the loan issuance operation 940 may comprise an operation in which a loan is issued against the digital wallet account 910 based on a trust profile associated with the participating entity 110 or against a collateralized virtual asset 980. In some aspects, the insurance underwriting operation 950 may comprise an operation in which coverage is underwritten for a virtual asset 980, including coverage against digital damage or theft applicable to one or more of an avatar storefront, a virtual tool, a virtual equipment item, an avatar, or a digital license.

In some aspects, the digital wallet account 910 may transmit, to the CipherVault execution governance system 100, an execution request 630 specifying a requested one of the banking operation 920, the escrow operation 930, the loan issuance operation 940, or the insurance underwriting operation 950 to be performed in respect of the virtual asset 980 or the digital wallet account 910 on behalf of the participating entity 110. In some aspects, the execution request 630 transmitted from the digital wallet account 910 may comprise a request to release, transfer, or settle the held digital payload 220, or to perform a banking operation, an escrow operation, a loan issuance operation, or an insurance underwriting operation as described above.

In some aspects, the CipherVault execution governance system 100 may receive, in connection with the execution request 630, the identity enforcement response 610 from the external identity infrastructure / CipherID 700 and the enforcement state vector 620 from the external legal execution infrastructure / CipherLaw 710. In some aspects, the identity enforcement response 610 may convey the authorization state and associated enforcement directives applicable to the participating entity 110 in respect of the execution request 630, including a status of the avatar / virtual business entity 140 within the external identity infrastructure / CipherID 700. In some aspects, the enforcement state vector 620 may encapsulate a regulatory, jurisdictional, or compliance-related enforcement status applicable to the banking operation 920, the escrow operation 930, the loan issuance operation 940, or the insurance underwriting operation 950 initiated by or on behalf of the participating entity 110.

In some aspects, the CipherVault execution governance system 100 may evaluate the execution request 630 against the execution governance payload 200 in light of the identity enforcement response 610 and the enforcement state vector 620, in the manner described with reference to FIGS. 3, 5, and 6, and may determine the enforcement outcome 240 specifying whether the requested one of the banking operation 920, the escrow operation 930, the loan issuance operation 940, or the insurance underwriting operation 950 is to be permitted, restricted, or denied. In some aspects, the CipherVault execution governance system 100 may populate the enforcement outcome 240 within the execution governance payload 200, increment the version identifier 216, and apply the cryptographic signature 218 to the updated execution governance payload 200 prior to outbound transmission.

In some aspects, the enforcement outcome 240 may include a routing directive that directs the requesting platform 122 to route the execution request 630 to a particular settlement endpoint, smart contract instance, counterparty, or platform of the plurality of independent computing environments 120 determined by the compliance state signal 810 and the enforcement state vector 620. In some aspects, the routing directive may direct the banking operation 920, the escrow operation 930, the loan issuance operation 940, or the insurance underwriting operation 950 along different execution paths depending on a current compliance state of the participating entity 110, such that operations originating from, directed to, or affecting assets located in different jurisdictions, different regulatory regimes, or different counterparty categories may be routed compliantly through corresponding settlement endpoints or smart contract instances. In some aspects, the routing directive carried by the enforcement outcome 240 may bind the requesting platform 122 and the receiving platform of the routing directive to enforce the enforcement outcome 240 and any associated conditional execution constraints 212 along the routed execution path, such that compliance-aware routing of operations may be performed under the authority of the CipherVault execution governance system 100.

In some aspects, the CipherVault execution governance system 100 may transmit the updated execution governance payload 200 carrying the enforcement outcome 240 to a smart contract 960 deployed on the distributed ledger network 720. In some aspects, the smart contract 960 may comprise a programmable contract deployed on the distributed ledger network 720 and configured to enforce one or more terms of the execution request 630 through execution on the distributed ledger network 720. In some aspects, upon receipt of the updated execution governance payload 200, the smart contract 960 may perform a sequence of sub-steps comprising (i) verifying the enforcement outcome 240 carried by the updated execution governance payload 200, including cryptographic verification of the cryptographic signature 218 and a check of the version identifier 216 in the manner described with reference to FIG. 7, (ii) applying contract terms encoded within the smart contract 960 that correspond to the requested one of the banking operation 920, the escrow operation 930, the loan issuance operation 940, or the insurance underwriting operation 950, (iii) executing a settlement / release / disbursement 970 with respect to the virtual asset 980, and (iv) recording a transaction on the distributed ledger network 720.

In some aspects, the settlement / release / disbursement 970 may comprise one or more of a settlement of funds against the digital wallet account 910, a release of the held digital payload 220 from the conditional holding state 520, a disbursement of loan proceeds in respect of the loan issuance operation 940, or a payment of coverage in respect of the insurance underwriting operation 950, performed in accordance with the enforcement outcome 240 carried by the updated execution governance payload 200. In some aspects, the virtual asset 980 may comprise one or more of a virtual storefront, a virtual tool, a virtual equipment item, an avatar, a digital license, or a non-fungible token associated with the participating entity 110, and the settlement / release / disbursement 970 may be effectuated with respect to the virtual asset 980 in accordance with the contract terms applied by the smart contract 960.

In some aspects, the distributed ledger network 720 may record the transaction effectuated by the smart contract 960 as a ledger entry, such that a tamper-resistant record of the settlement / release / disbursement 970 and of the corresponding application of the execution governance payload 200 by the smart contract 960 may be maintained on the distributed ledger network 720. In some aspects, the CipherVault execution governance system 100 may further interface with the distributed ledger network 720 to maintain an automated audit log 990, in which ledger-based transaction tracking is performed for operations executed against the digital wallet account 910, including the banking operation 920, the escrow operation 930, the loan issuance operation 940, and the insurance underwriting operation 950. In some aspects, the automated audit log 990 may comprise an aggregation of enforcement state records 242 and transaction records recorded on the distributed ledger network 720, such that each authorization decision, each enforcement outcome 240, and each settlement / release / disbursement 970 performed by the smart contract 960 in respect of the virtual asset 980 may be persistently logged in a tamper-resistant form available to the plurality of independent computing environments 120.

In some aspects, the commercial metaverse banking embodiment depicted in FIG. 13 may encompass a range of non-limiting use cases. In some aspects, a first use case may comprise auto-deduction of rent from virtual booth rental earnings of an avatar participating entity 110, performed as a recurring banking operation 920 against the digital wallet account 910. In some aspects, a second use case may comprise an escrow operation 930 holding the held digital payload 220 in respect of a sale of a high-value avatar wearable non-fungible token, with release of the held digital payload 220 to a beneficiary 118 upon satisfaction of an event predicate 224 indicating completion of transfer of the avatar wearable non-fungible token. In some aspects, a third use case may comprise a loan issuance operation 940 in which a virtual loan is issued against the digital wallet account 910 to fund acquisition of in-world equipment, with the in-world equipment serving as a collateralized virtual asset 980. In some aspects, a fourth use case may comprise an insurance underwriting operation 950 in which coverage for a non-fungible token virtual asset 980 is underwritten against digital damage or theft.

In some aspects, the participating entity 110 may be associated with the digital wallet account 910 linked to the avatar / virtual business entity 140, the execution request 630 may comprise a request to perform at least one of the banking operation 920, the escrow operation 930, the loan issuance operation 940, or the insurance underwriting operation 950 in respect of the virtual asset 980, and the CipherVault execution governance system 100 may enforce one or more terms of the execution request 630 through execution of the smart contract 960 deployed on the distributed ledger network 720.

In some aspects, the CipherVault execution governance system 100 may support a plurality of representative use cases that illustrate practical application of the banking operation 920, the escrow operation 930, the loan issuance operation 940, and the insurance underwriting operation 950 to the digital wallet account 910 and the virtual asset 980. The representative use cases described below are non-limiting examples, and the CipherVault execution governance system 100 may support additional combinations of operations within the scope of the present disclosure.

In some aspects, a representative use case may comprise an event-based escrow release in respect of a sale of a high-value avatar skin. In some aspects, the held digital payload 220 may comprise funds tendered by a buyer participating entity 110 in payment for the high-value avatar skin, and the virtual asset 980 may comprise the high-value avatar skin offered for sale by a seller participating entity 110. In some aspects, the held digital payload 220 may be deposited with the CipherVault execution governance system 100 and maintained in the conditional holding state 520 pending satisfaction of an event-based release condition encoded as an event predicate 224. In some aspects, the event predicate 224 may comprise a counterparty confirmation event signal supplied by the buyer participating entity 110, or by the oracle / external data source 730 acting on behalf of the buyer participating entity 110, that verifies receipt by the buyer participating entity 110 of the high-value avatar skin. In some aspects, upon evaluation by the evaluator / outcome determinator 340 that the counterparty confirmation event signal satisfies the event predicate 224, the enforcement outcome 240 may be determined as a permit release outcome, and the held digital payload 220 may be released from the conditional holding state 520 to a beneficiary 118 comprising the seller participating entity 110. In some aspects, release of the held digital payload 220 to the beneficiary 118 may be conditioned on receipt of the counterparty confirmation event signal verifying receipt of the high-value avatar skin, such that the held digital payload 220 is not released until the high-value avatar skin has been received by the buyer participating entity 110.

In some aspects, a further representative use case may comprise a metaverse trust profile loan issued by way of the loan issuance operation 940. In some aspects, the loan issuance operation 940 may employ a loan approval engine that evaluates eligibility of the participating entity 110 for a loan based on a metaverse-derived trust profile associated with the participating entity 110. In some aspects, the metaverse-derived trust profile may comprise one or more of a transaction history of the participating entity 110 within one or more immersive platforms, a reputation score associated with the avatar / virtual business entity 140, a record of prior loan repayments by the participating entity 110, a record of prior commercial activity by the avatar / virtual business entity 140, or a record of compliance of the participating entity 110 with prior enforcement outcomes 240 determined by the CipherVault execution governance system 100. In some aspects, the loan approval engine may evaluate eligibility of the participating entity 110 based on the metaverse-derived trust profile in addition to, or in lieu of, a collateralized virtual asset 980, such that a loan may be issued against the digital wallet account 910 without a collateralized virtual asset 980 where the metaverse-derived trust profile satisfies one or more eligibility criteria applied by the loan approval engine. In some aspects, upon approval of the loan by the loan approval engine, the smart contract 960 may execute disbursement of loan proceeds to the digital wallet account 910 as a settlement / release / disbursement 970 in accordance with terms encoded within the smart contract 960.

In some aspects, a further representative use case may comprise a peer-to-peer landlord-to-renter loan issued by way of the loan issuance operation 940 within a gamified city economy. In some aspects, the loan issuance operation 940 may support peer-to-peer loan issuance in which a digital landlord participating entity 110 offers loans to one or more renter participating entities 110 operating within the gamified city economy. In some aspects, the digital landlord participating entity 110 may comprise an avatar / virtual business entity 140 that owns or operates virtual real estate within an immersive platform and that extends credit to one or more renter participating entities 110 occupying the virtual real estate. In some aspects, terms of the peer-to-peer loan, including a principal amount, an interest rate, a repayment schedule, and a default condition, may be encoded within a smart contract 960 deployed on the distributed ledger network 720, such that the smart contract 960 enforces the terms of the peer-to-peer loan between the digital landlord participating entity 110 and the renter participating entity 110. In some aspects, the smart contract 960 may credit interest payments to a digital wallet account 910 of the digital landlord participating entity 110 in accordance with the encoded terms, such that the digital landlord participating entity 110 earns interest on the peer-to-peer loan. In some aspects, the CipherVault execution governance system 100 may evaluate execution requests 630 associated with the peer-to-peer loan against the execution governance payload 200 associated with each of the digital landlord participating entity 110 and the renter participating entity 110.

In some aspects, a further representative use case may comprise an equipment-collateralized virtual loan in which a car wash owner participating entity 110 secures a virtual loan to acquire new in-world equipment for use within an immersive platform. In some aspects, the car wash owner participating entity 110 may comprise an avatar / virtual business entity 140 that operates a virtual car wash within the immersive platform, and the new in-world equipment may comprise one or more virtual tools or virtual equipment items used in the operation of the virtual car wash. In some aspects, the loan issuance operation 940 may comprise disbursement of loan proceeds to the digital wallet account 910 of the car wash owner participating entity 110 to fund acquisition of the new in-world equipment, with the new in-world equipment serving as a collateralized virtual asset 980 tracked on the distributed ledger network 720. In some aspects, tracking of the new in-world equipment as the collateralized virtual asset 980 on the distributed ledger network 720 may comprise recording, on the distributed ledger network 720, an ownership record, a transfer record, and a status record associated with the new in-world equipment, such that the new in-world equipment is verifiable as collateral in connection with the virtual loan. In some aspects, upon a default condition associated with the virtual loan, the smart contract 960 may transfer ownership of the collateralized virtual asset 980 from the car wash owner participating entity 110 to a lender participating entity 110 in accordance with terms encoded within the smart contract 960.

In some aspects, a further representative use case may comprise smart-contract repayment enforcement applied to a loan issued by way of the loan issuance operation 940. In some aspects, the smart contract 960 may encode a repayment schedule comprising one or more scheduled repayment intervals at which a repayment amount is to be debited from the digital wallet account 910 of the participating entity 110. In some aspects, upon arrival of each scheduled repayment interval, the smart contract 960 may automatically debit the digital wallet account 910 of the participating entity 110 by the repayment amount and may credit the repayment amount to a digital wallet account 910 of a lender participating entity 110, in accordance with the encoded repayment schedule. In some aspects, the automatic debit performed by the smart contract 960 may comprise a settlement / release / disbursement 970 effectuated against the digital wallet account 910 of the participating entity 110, and the CipherVault execution governance system 100 may evaluate each automatic debit against the execution governance payload 200 associated with the participating entity 110 prior to execution by the smart contract 960. In some aspects, upon a failure of the automatic debit, including by reason of insufficient funds in the digital wallet account 910 or a restricted authorization state field 210 of the participating entity 110, the smart contract 960 may record a missed-repayment event on the distributed ledger network 720 and may invoke one or more remedial actions encoded within the smart contract 960, including assessment of a late fee, modification of the repayment schedule, or transfer of a collateralized virtual asset 980 from the participating entity 110 to the lender participating entity 110.

In some aspects, the present disclosure provides a plurality of technical improvements to the operation of computing infrastructure that coordinates conditional execution of operations across a plurality of independent computing environments, and the disclosed techniques are integrated into a practical application of governing release, transfer, and settlement of digital payloads held in a conditional holding state across synchronous, asynchronous, and distributed environments. The technical improvements described herein address computing-centric problems that arise in distributed and heterogeneous platform architectures and that do not arise outside the context of networked computing systems, including divergent enforcement state across independent platforms, lack of cross-platform propagation of authorization changes, version skew among platforms receiving asynchronous updates, missed or invalid acknowledgments of state changes, and tamper-susceptibility of authorization records maintained in conventional databases.

In some aspects, a first technical improvement may comprise the generation, propagation, and enforcement of a machine-readable execution governance payload that operates as an authoritative execution condition binding each of a plurality of heterogeneous independent computing environments to apply a consistent authorization state, a consistent set of conditional execution constraints, and a consistent set of enforcement directives with respect to a participating entity. In conventional arrangements, each platform evaluates authorization locally on the basis of credentials, tokens, or on-chain inputs that are visible only to that platform, with the consequence that an authorization decision rendered at one platform may not be reflected at another and that a change in the status of the participating entity at one platform may not be observed at another. In some aspects, the machine-readable execution governance payload described herein replaces such platform-local evaluation with a structured, machine-parseable governance artifact that is generated by a central execution governance system, distributed in parallel to each platform on which the participating entity may act, and applied at each platform as the authoritative execution condition governing whether a requested operation on a held digital payload is to be permitted, restricted, or denied. In some aspects, this arrangement improves the operation of the computing infrastructure itself by providing a uniform, machine-enforced mechanism for cross-platform authorization that does not require each platform to independently re-derive an authorization decision from disparate inputs.

In some aspects, a further technical improvement may comprise cryptographic signing of the execution governance payload and recording of enforcement state records on a distributed ledger network. In conventional arrangements, records of authorization decisions and enforcement actions are typically maintained in databases that are subject to modification by an operator of the database and that may not be readily accessible across platforms or jurisdictions. In some aspects, the cryptographic signature applied to the execution governance payload may permit each of the plurality of independent computing environments to verify, prior to application of an enforcement outcome, both the authenticity of the execution governance payload and the integrity of the contents of the execution governance payload, and to refuse application of the enforcement outcome upon failure of verification. In some aspects, the recording of an enforcement state record corresponding to the enforcement outcome on a distributed ledger network may provide a tamper-resistant, cryptographically protected record of authorization decisions and enforcement actions that is available to any participating platform for verification, such that the technical problem of tamper-susceptible authorization records maintained in conventional databases is mitigated through use of cryptographic primitives and ledger-based persistence.

In some aspects, a further technical improvement may comprise the use of a monotonically increasing version identifier carried by the execution governance payload to prevent application of stale state at any of the plurality of independent computing environments. In conventional cross-platform arrangements in which authorization updates are propagated asynchronously, downstream platforms may receive updates at different times, may receive updates out of order, or may fail to receive an update at all, with the consequence that one platform may apply an older authorization state than another platform for the same participating entity. In some aspects, by incrementing the version identifier upon each update to the execution governance payload and by causing each platform to compare a received version identifier against a latest version identifier previously received for the participating entity, an execution governance payload bearing an earlier version identifier may be rejected as stale, such that version skew across the plurality of independent computing environments is mitigated and a consistent ordering of authorization states is maintained.

In some aspects, a further technical improvement may comprise an acknowledgment-and-reconciliation workflow that ensures convergent enforcement state across the plurality of independent computing environments. In some aspects, each platform that receives the execution governance payload may return an acknowledgment signal confirming application of the enforcement outcome, and a reconciliation engine of the execution governance system may evaluate whether each acknowledgment signal is valid, may record an enforcement state record corresponding to a valid acknowledgment signal on a distributed ledger network, and may, upon a determination that an acknowledgment signal is invalid or that no acknowledgment signal has been received from a particular environment within a timeout period, retransmit the execution governance payload to the particular environment until a valid acknowledgment signal is received. In some aspects, the acknowledgment-and-reconciliation workflow improves the operation of the computing infrastructure by providing a deterministic, automated mechanism for detecting and remediating missed or invalid acknowledgments arising from network conditions, platform-side processing delays, or operating-mode differences, such that a consistent enforcement state may be converged upon across synchronous, asynchronous, and distributed environments notwithstanding differences in connectivity, processing latency, or operating mode.

In some aspects, a further technical improvement may comprise invalidation of a transient execution environment associated with a held digital payload following execution completion, rollback, or reversion, in the form of a zero-residue cleansing of the transient execution environment. In some aspects, the zero-residue cleansing may comprise clearing, from the transient execution environment, ephemeral state, intermediate computation artifacts, and cached credentials associated with an execution request, such that residual artifacts that could be exploited to infer authorization state, replay authorization decisions, or otherwise compromise security of subsequent execution requests are removed from the transient execution environment. In some aspects, the transient-environment invalidation improves the operation of the computing infrastructure by mitigating the technical problem of residual artifacts persisting in transient execution environments following completion of governed operations.

In some aspects, a further technical improvement may comprise binding of an execution authority of an automated software agent, including an artificial-intelligence agent, to a participating entity by way of a parent-identity reference and an agent scope encoded in the execution governance payload, together with propagation of updates to the execution governance payload that remove or modify the agent scope to each of the plurality of independent computing environments. In some aspects, this arrangement may improve the operation of the computing infrastructure by providing a uniform, machine-enforced mechanism for scoping and revoking agent authority across heterogeneous platforms, such that revocation or modification of the agent scope is reflected consistently across the platforms on which the agent may act, rather than being applied platform-by-platform with the attendant risk of divergent enforcement.

In some aspects, the technical improvements described herein are integrated into a practical application of governing release, transfer, and settlement of held digital payloads across a plurality of independent computing environments that operate in synchronous, asynchronous, and distributed modes. In some aspects, the practical application comprises generating the machine-readable execution governance payload, receiving an execution request from a requesting platform to release, transfer, or settle a held digital payload, evaluating the execution request against the execution governance payload in light of an identity enforcement response, an enforcement state vector, a compliance state signal, and an event predicate, determining an enforcement outcome that specifies whether release, transfer, or settlement of the held digital payload is to be permitted, restricted, or denied, and propagating the execution governance payload as updated to reflect the enforcement outcome to each of the plurality of independent computing environments as the authoritative execution condition. In some aspects, the practical application further comprises effectuating release, transfer, or settlement of the held digital payload at the requesting platform and at additional platforms of the plurality of independent computing environments in accordance with the enforcement outcome, and recording corresponding enforcement state records on a distributed ledger network.

In some aspects, the techniques described herein operate on machine-readable governance artifacts that are cryptographically signed, that are propagated in parallel across a plurality of networked independent computing environments, that are verified at each environment by cryptographic verification of a digital signature and by comparison of a monotonically increasing version identifier against a latest version identifier previously received, and that are reconciled across the environments by an automated acknowledgment-and-reconciliation workflow operating against timeout periods maintained by the execution governance system. In some aspects, the techniques described herein further effectuate state transitions of a held digital payload across a programmable intermediary holding state, a released state, a frozen state, a suspended state, a revoked state, an expired state, a rolled-back state, and a transient-environment-invalidated state, with each state transition being effectuated by machine-executable directives carried by the execution governance payload and being applied uniformly across the plurality of independent computing environments. In some aspects, the techniques described herein may be performed by one or more processors executing instructions stored on a non-transitory computer-readable storage medium that effectuate the generation, cryptographic signing, propagation, evaluation, reconciliation, and ledger-based recording of the execution governance payload across networked computing environments.

In some aspects, the technical improvements and practical application described herein may collectively provide a computing infrastructure in which authorization decisions and enforcement actions taken with respect to a participating entity and a held digital payload are uniformly observed, cryptographically verifiable, version-ordered, acknowledgment-reconciled, and tamper-resistantly recorded across a plurality of independent computing environments, such that divergent enforcement state, propagation gaps, version skew, missed or invalid acknowledgments, and tamper-susceptibility of authorization records associated with conventional cross-platform arrangements may be mitigated.

Machine readable storage including machine-readable instructions, when executed, to implement a method or realize an apparatus in any of the examples of the present application.

Various techniques, or certain aspects or portions thereof, may take the form of program code (i.e., instructions) embodied in tangible media, such as floppy diskettes, CD-ROMs, hard drives, a non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. The eNB (or other base station) and UE (or other mobile station) may also include a transceiver component, a counter component, a processing component, and/or a clock component or timer component. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or an interpreted language, and combined with hardware implementations.

It should be understood that many of the functional units described in this specification may be implemented as one or more components, which is a term used to more particularly emphasize their implementation independence. For example, a component may be implemented as a hardware circuit comprising custom very large scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together, but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

Reference throughout this specification to "an example" means that a particular feature, structure, or characteristic described in connection with the example is included in at least one embodiment of the present invention. Thus, appearances of the phrase "in an example" in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the invention is not to be limited to the details given herein, but may be modified within the scope and equivalents of the appended claims.

Those having skill in the art will appreciate that many changes may be made to the details of the above-described embodiments without departing from the underlying principles of the invention. The scope of the present invention should, therefore, be determined only by the following claims.

1. A method for governing conditional execution of operations across a plurality of independent computing environments, comprising:
generating, by one or more processors, a machine-readable execution governance payload associated with a participating entity, the execution governance payload encapsulating (i) an authorization state of the participating entity, (ii) one or more conditional execution constraints applicable to the participating entity, and (iii) one or more enforcement directives;
receiving, by the one or more processors, from a requesting platform of the plurality of independent computing environments, an execution request to release, transfer, or settle a digital payload held in a conditional holding state on behalf of the participating entity;
evaluating, by the one or more processors, the execution request against the execution governance payload, and determining, in accordance with the one or more enforcement directives, an enforcement outcome that specifies whether release, transfer, or settlement of the held digital payload is to be permitted, restricted, or denied; and
enforcing, by the one or more processors, the enforcement outcome across the plurality of independent computing environments, including the requesting platform, by propagating the execution governance payload, as updated to reflect the enforcement outcome, to the plurality of independent computing environments as an authoritative execution condition that binds each of the plurality of independent computing environments to apply the enforcement outcome with respect to the held digital payload and to apply the authorization state, the conditional execution constraints, and the enforcement directives with respect to the participating entity across pending and subsequent execution requests.

2. The method of claim 1, wherein the execution governance payload is signed with a cryptographic signature and recorded on a distributed ledger network.

3. The method of claim 1, wherein the authorization state is derived at least in part from an identity enforcement response received from an external identity infrastructure, the identity enforcement response comprising a machine-readable payload that includes enforcement directives associated with the participating entity.

4. The method of claim 1, wherein evaluating the execution request comprises evaluating the execution governance payload against an enforcement state vector received from an external legal execution infrastructure, the enforcement state vector encapsulating enforcement status of the participating entity.

5. The method of claim 1, wherein the one or more conditional execution constraints comprise at least one of a delegated permission, a jurisdictional restriction, a compliance condition, or a behavioral restriction.

6. The method of claim 1, wherein the execution request is initiated by an artificial-intelligence agent bound to the participating entity, and wherein the one or more conditional execution constraints constrain an execution authority of the artificial-intelligence agent relative to the participating entity.

7. The method of claim 1, wherein the held digital payload is maintained in a programmable intermediary holding state pending satisfaction of a release condition, and wherein the method further comprises one or more of: transitioning the execution governance payload into a freeze state, a suspend state, or a revoke state; causing automatic expiration of the execution governance payload upon elapse of a temporal timeout; initiating a rollback that reverts a state of the held digital payload upon failure or invalidation; and invalidating a transient execution environment associated with the execution request following execution completion, rollback, or reversion.

8. The method of claim 1, further comprising: receiving, by the one or more processors, from each of one or more of the plurality of independent computing environments, an acknowledgment signal confirming application of the enforcement outcome; evaluating, by the one or more processors, whether each acknowledgment signal is valid; upon determining that an acknowledgment signal is valid, recording, by the one or more processors, an enforcement state record corresponding to the acknowledgment signal; and upon determining that an acknowledgment signal is invalid, or upon expiration of a timeout period without receipt of the acknowledgment signal from a particular environment of the plurality of independent computing environments, initiating, by the one or more processors, a reconciliation process comprising retransmitting the execution governance payload, as updated to reflect the enforcement outcome, to the particular environment.

9. The method of claim 1, wherein the execution governance payload includes a monotonically increasing version identifier, and wherein the method further comprises propagating the version identifier with the execution governance payload such that each of the plurality of independent computing environments rejects, as stale, any execution governance payload bearing a version identifier earlier than a latest version identifier previously received for the participating entity.

10. The method of claim 2, further comprising causing each of the plurality of independent computing environments to cryptographically verify the cryptographic signature of the execution governance payload prior to applying the enforcement outcome, and to refuse to apply the enforcement outcome upon failure of verification.

11. The method of claim 7, wherein the release condition comprises an event predicate evaluable against at least one of an external data source, an oracle input, a counterparty confirmation signal, or a time-based trigger, and wherein release of the held digital payload to a designated recipient is conditioned on satisfaction of the event predicate.

12. The method of claim 6, wherein the artificial-intelligence agent is bound to the participating entity by a parent-identity reference encoded in the execution governance payload, wherein a scope of the execution authority of the artificial-intelligence agent is encoded in the execution governance payload, and wherein operations of the artificial-intelligence agent are revocable by updating the execution governance payload to remove or modify the scope.

13. A networked computing system for governing conditional execution of operations across a plurality of independent computing environments, comprising: one or more hardware processors; and a non-transitory memory storing instructions that, when executed by the one or more hardware processors, cause the system to: generate a machine-readable execution governance payload associated with a participating entity, the execution governance payload encapsulating (i) an authorization state of the participating entity, (ii) one or more conditional execution constraints applicable to the participating entity, and (iii) one or more enforcement directives; receive, from a requesting platform of the plurality of independent computing environments, an execution request to release, transfer, or settle a digital payload held in a conditional holding state on behalf of the participating entity; evaluate the execution request against the execution governance payload, and determine, in accordance with the one or more enforcement directives, an enforcement outcome that specifies whether release, transfer, or settlement of the held digital payload is to be permitted, restricted, or denied; and enforce the enforcement outcome across the plurality of independent computing environments, including the requesting platform, by propagating the execution governance payload, as updated to reflect the enforcement outcome, to the plurality of independent computing environments as an authoritative execution condition that binds each of the plurality of independent computing environments to apply the enforcement outcome with respect to the held digital payload and to apply the authorization state, the conditional execution constraints, and the enforcement directives with respect to the participating entity across pending and subsequent execution requests.

14. The networked computing system of claim 13, wherein the execution governance payload comprises a cryptographically signed, machine-readable data structure that is recorded on a distributed ledger network.

15. The networked computing system of claim 13, wherein the instructions further cause the system to expose an application programming interface configured to permit a third-party platform of the plurality of independent computing environments to submit execution requests and to receive resulting enforcement outcomes specifying that release, transfer, or settlement of the held digital payload is permitted, restricted, or denied.

16. The networked computing system of claim 13, wherein the execution request comprises a request to perform at least one of a transfer, a settlement, a release, an asset movement, a delegated action, or an operation initiated by an artificial-intelligence agent bound to the participating entity, with respect to the held digital payload.

17. The networked computing system of claim 13, wherein the one or more conditional execution constraints include a jurisdictional restriction, and wherein the instructions further cause the system to evaluate a geographic parameter associated with the execution request against the jurisdictional restriction.

18. The networked computing system of claim 13, wherein the participating entity is associated with a digital wallet account linked to an avatar or a virtual business entity, wherein the execution request comprises a request to perform at least one of a banking operation, an escrow operation, a loan issuance operation, or an insurance underwriting operation in respect of a virtual asset, and wherein the instructions further cause the system to enforce one or more terms of the execution request through execution of a smart contract deployed on a distributed ledger.

19. The networked computing system of claim 13, wherein the instructions further cause the system to: receive, from each of one or more of the plurality of independent computing environments, an acknowledgment signal confirming application of the enforcement outcome; evaluate whether each acknowledgment signal is valid; upon determining that an acknowledgment signal is valid, record an enforcement state record corresponding to the acknowledgment signal; and upon determining that an acknowledgment signal is invalid, or upon expiration of a timeout period without receipt of the acknowledgment signal from a particular environment of the plurality of independent computing environments, initiate a reconciliation process comprising retransmitting the execution governance payload, as updated to reflect the enforcement outcome, to the particular environment.

20. A computer program product comprising a non-transitory computer-readable storage medium storing instructions that, when executed by one or more processors, cause the one or more processors to perform the method of claim 1.
